(19) United States
(12) Patent Application Publication
(10) Pub. No.: US 2018/0260068 A1
(43) Pub. Date: Sep. 13, 2018

(54) INPUT DEVICE, INPUT CONTROL METHOD, AND COMPUTER PROGRAM

(71) Applicant: SEIKO EPSON CORPORATION, Tokyo (JP)

(72) Inventor: Yoshiaki HIROI, Matsumoto-shi (JP)

(73) Assignee: SEIKO EPSON CORPORATION, Tokyo (JP)

(21) Appl. No.: 15/909,109

(22) Filed: Mar. 1, 2018

(30) Foreign Application Priority Data
Mar. 13, 2017 (JP) 2017-047534

(51) Int. Cl. G06F 3/041; G06F 3/044; G06F 3/042; G02B 27/01

(52) U.S. Cl. CPC G06F 3/0416; G06F 3/044; G06F 3/04883; G02B 27/0172; G06F 3/0425

(57) ABSTRACT

An input device includes a plurality of operation units including an operation unit having an operation surface for receiving a touch operation; a contact detector that detects contact portions on the operation surface; a gripping state detector that detects a gripping state of the input device; and a control unit that processes an input from the operation unit, the control unit invalidates an input from a contact portion determined according to the detected gripping state, among the detected contact portions.

### BACKGROUND

### 1. Technical Field

The present invention relates to an input device.

### 2. Related Art

A head mounted display (HMD) has been known which is worn on the user's head and displays images or the like within the user's viewing area. The head mounted display allows the user to recognize a virtual image by guiding the image light generated using a liquid crystal display and a light source to the user's eye using a projection optical system, a light guide plate or the like, for example. As an input device for the user to control the head mounted display, a controller having a plurality of operation units such as buttons and track pads is used. In general, an area occupied by the track pad in the controller is larger than an area occupied by other operation units. Thus, for example, when trying to operate a button with a fingertip, a problem may arise that an area near the base of a finger accidentally touches the track pad, resulting in erroneous input. A place where erroneous input occurs depends on a user's holding method of the controller. Japanese Patent No. 5970280 discloses a technique of determining a holding method of an input device using a sensor provided on the side surface of the input device and restricting an input at a predetermined fixed area of the track pad according to the determined holding method.

However, in the technique described in Japanese Patent No. 5970280, since an area where an input is restricted is uniformly set, even though an available area for input is slightly widened due to a slight difference in the position of the finger, an input possible area is unnecessarily reduced, and the usability at the time of input deteriorates. Therefore, for example, there is a problem that a gesture input by a multi-touch using a plurality of fingers, for example, a so-called pinch in/pinch out or the like cannot be used, or a range that can be enlarged by such a gesture input narrows. This problem occurs not only in the input device of the head mounted display, but also in input devices including a plurality of operation units. Therefore, a technique capable of suppressing the reduction of the input possible area in the input device and reducing erroneous input is desired.

### SUMMARY

An advantage of some aspects of the invention is to solve at least a part of the problems described above, and the invention can be implemented as the following aspects or embodiments.

(1) According to an aspect of the invention, an input device is provided. The input device includes a plurality of operation units including an operation unit having an operation surface for receiving a touch operation; a contact detector that detects contact portions on the operation surface; a gripping state detector that detects a gripping state of the input device; and a control unit that processes an input from the operation unit, the control unit invalidates an input from a contact portion determined according to the detected gripping state, among the detected contact portions.

According to the input device of the aspect, the input device includes a contact detector that detects the contact portion on the operation surface and a gripping state detector that detects the gripping state of the input device, and invalidates an input from the contact portion determined according to the detected gripping state, among the detected contact portions, so erroneous input can be reduced, and a reduction of an input possible area can be suppressed, as compared to a configuration in which input from a contact portion of a predetermined area is invalidated regardless of the gripping state.

(2) In the input device of the aspect, the gripping state may include the direction of the input device. According to the input device of the aspect with this configuration, it is possible to invalidate the input from the contact portion determined according to the direction of the input device.

(3) In the input device of the aspect, the gripping state may include a holding method of the input device. According to the input device of the aspect with this configuration, it is possible to invalidate the input from the contact portion determined according to the holding method of the input device.

(4) In the input device of the aspect, the gripping state detector may detect the gripping state, by using at least one of the number of the contact portions, an area of each of the contact portions, and a position of each of the contact portions.

According to the input device of the aspect with this configuration, since the gripping state is detected by using at least one of the number of the contact portions, an area of each of the contact portions, and a position of each of the contact portions, the gripping state can be accurately detected.

(5) In the input device of the aspect, the gripping state may include a single-touch and a multi-touch on the operation surface, the gripping state detector may specify a support contact portion for supporting the input device among the contact portions, and may distinguish between the single-touch and the multi-touch, based on the number of contact portions excluding the specified support contact portion, among the contact portions.

According to the input device of the aspect with this configuration, a support contact portion for supporting the input device among contact portions is specified, and it is distinguished between single-touch and multi-touch based on the number of contact portions excluding the specified support contact portion, among the contact portions, it can be distinguished between the single-touch and the multi-touch with high accuracy.

(6) The input device of the aspect may further include a display control unit that causes a display device connected to the input device to display a notification in a case where there is an input to be invalidated in the contact portion.

According to the input device of the aspect with this configuration, since the display device connected to the input device is caused to display a notification in a case where there is an input to be invalidated in the contact portion, the user can know that an invalid input is performed, and thus convenience is improved.

(7) In the input device of the aspect, the display device may be a head mounted display. According to the input device of the aspect with this configuration, in a case where the user wears the head mounted display on the head and operates it without looking at the operation unit, the user can easily know that there is an input to be invalidated, thereby improving user convenience.

The invention can be realized in various forms. For example, the invention can be realized in the form of an input control method of an input device, a computer program for realizing such an input control method, a recording medium in which such a computer program is recorded, and the like.

### BRIEF DESCRIPTION OF THE DRAWINGS

The invention will be described with reference to the accompanying drawings, wherein like numbers reference like elements.

FIG. 1 is an explanatory diagram illustrating a schematic configuration of an input device according to an embodiment of the invention.

FIG. 2 is a plan view of a main part illustrating a configuration of an optical system included in an image display unit.

FIG. 3 is a diagram illustrating a configuration of main parts of the image display unit viewed from a user.

FIG. 4 is a diagram illustrating an angle of view of a camera.

FIG. 5 is a block diagram functionally illustrating a configuration of an HMD.

FIG. 6 is a block diagram functionally illustrating a configuration of the input device.

FIG. 7 is an explanatory diagram schematically illustrating a first gripping state of the input device.

FIG. 8 is an explanatory diagram schematically illustrating a second gripping state of the input device.

FIG. 9 is an explanatory diagram schematically illustrating a third gripping state of the input device.

FIG. 10 is an explanatory diagram schematically illustrating a fourth gripping state of the input device.

FIG. 11 is an explanatory diagram schematically illustrating a fifth gripping state of the input device.

FIG. 12 is an explanatory diagram schematically illustrating a sixth gripping state of the input device.

FIG. 13 is an explanatory diagram schematically illustrating a seventh gripping state of the input device.

FIG. 14 is an explanatory diagram schematically illustrating an eighth gripping state of the input device.

FIG. 15 is an explanatory diagram schematically illustrating an example of a contact portion detected in the first gripping state.

FIG. 16 is a flowchart illustrating the procedure of an input receiving process.

FIG. 17 is a flowchart illustrating the procedure of a gripping state detection process in detail.

FIG. 18 is a flowchart illustrating the procedure of an input process in detail.

FIG. 19 is an explanatory diagram schematically illustrating an area in which an input determined according to the first gripping state is invalidated.

FIG. 20 is an explanatory diagram schematically illustrating a state of the input process in the first gripping state.

FIG. 21 is an explanatory diagram schematically illustrating an area in which an input determined according to the third gripping state is invalidated.

FIG. 22 is an explanatory diagram schematically illustrating a state of the input process in the third gripping state.

FIG. 23 is an explanatory diagram schematically illustrating an area in which an input determined according to the fifth gripping state is invalidated.

FIG. 24 is an explanatory diagram schematically illustrating a state of the input process in the fifth gripping state.

FIG. 25 is an explanatory diagram schematically illustrating an area in which an input determined according to the seventh gripping state is invalidated.

FIG. 26 is an explanatory diagram schematically illustrating an example of the input process in the seventh gripping state.

FIG. 27 is an explanatory diagram schematically illustrating an example of a notification display in the seventh gripping state.

### DESCRIPTION OF EXEMPLARY EMBODIMENTS

### A. Embodiment

### A1. Schematic Configuration of Input Device:

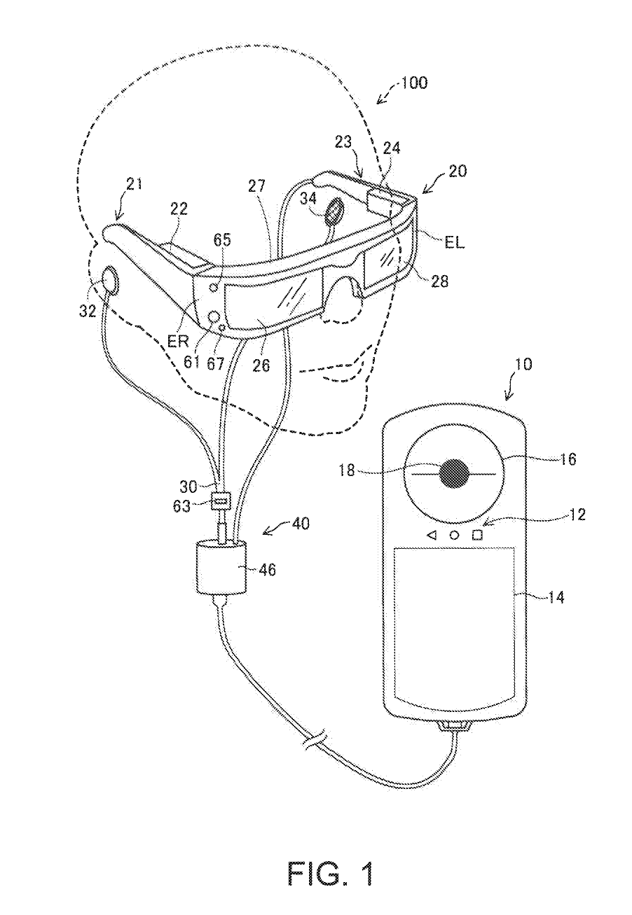

FIG. 1 is an explanatory diagram illustrating a schematic configuration of an input device according to an embodiment of the invention. FIG. 1 also illustrates a schematic configuration of a head mounted display 100 controlled by an input device 10. The head mounted display 100 is a display device mounted on the user's head, and is also referred to as an HMD. The HMD 100 is a see-through type (a transmissive type) head mounted display in which an image appears in the outside world viewed through a glass.

The HMD 100 includes an image display unit 20 that allows the user to view an image, and the input device (controller) 10 that controls the HMD 100.

The image display unit 20 is a wearing object to be worn on the head of the user, and has a glasses shape in the present embodiment. The image display unit 20 includes a right display unit 22, a left display unit 24, a right light guide plate 26, and a left light guide plate 28, in a supporting body having a right holding unit 21, a left holding unit 23, and a front frame 27.

The right holding unit 21 and the left holding unit 23 respectively extend rearward from both end portions of the front frame 27, and hold the image display unit 20 on the head of the user like a temple of glasses. Among the both end portions of the front frame 27, the end portion located on the right side of the user in the state of wearing the image display unit 20 is referred to as the end portion ER, and the end portion located on the left side of the user is referred to as the end portion EL. The right holding unit 21 extends from the end portion ER of the front frame 27 to a position corresponding to the right lateral head of the user in the state of wearing the image display unit 20. The left holding unit 23 extends from the end portion EL of the front frame 27 to a position corresponding to the left lateral head of the user in the state of wearing the image display unit 20.

The right light guide plate 26 and the left light guide plate 28 are provided on the front frame 27. The right light guide plate 26 is located in front of the user's right eye in the state of wearing the image display unit 20, and causes the right eye to view an image. The left light guide plate 28 is located in front of the user's left eye in the state of wearing the image display unit 20, and causes the left eye to view an image.

The front frame 27 has a shape in which one end of the right light guide plate 26 and one end of the left light guide plate 28 are connected to each other. The connection position corresponds to the position of the middle of the forehead of the user in the state of wearing the image display unit 20. A nose pad contacting the user's nose may be provided in the front frame 27 in the state of wearing the image display unit 20, at the connection position between the right light guide plate 26 and the left light guide plate 28. In this case, the image display unit 20 can be held on the head of the user by the nose pad, the right holding unit 21, and the left holding unit 23. A belt that contacts the back of the user's head may be connected to the right holding unit 21 and the left holding unit 23 in the state of wearing the image display unit 20. In this case, the image display unit 20 can be firmly held on the user's head by the belt.

The right display unit 22 displays an image by the right light guide plate 26. The right display unit 22 is provided in the right holding unit 21, and is located in the vicinity of the right lateral head of the user in the state of wearing the image display unit 20. The left display unit 24 displays an image by the left light guide plate 28. The left display unit 24 is provided in the left holding unit 23, and is located in the vicinity of the left lateral head of the user in the state of wearing the image display unit 20.

The right light guide plate 26 and the left light guide plate 28 of this embodiment are optical sections (for example, prisms) made of a light transmissive resin or the like, and guide the image light output by the right display unit 22 and the left display unit 24 to the eye of the user. A light control plate may be provided on the surfaces of the right light guide plate 26 and the left light guide plate 28. The light control plate is a thin plate-like optical element having different transmittance depending on the wavelength range of light, and functions as a so-called wavelength filter. For example, the light control plate is arranged so as to cover the surface of the front frame 27 (the surface opposite to the surface facing the user's eye). It is possible to adjust the transmittance of light in an arbitrary wavelength range such as visible light, infrared light, and ultraviolet light, and to adjust the light intensity of the external light incident on the right light guide plate 26 and the left light guide plate 28 from the outside and passing through the right light guide plate 26 and the left light guide plate 28, by appropriately selecting the optical characteristics of the light control plate.

The image display unit 20 guides the image light generated by the right display unit 22 and the left display unit 24 respectively to the right light guide plate 26 and the left light guide plate 28, and allows the user to view the image (augmented reality (AR) image) by the image light (this is also referred to as “displaying image”) in addition to the scenery of an outside world viewed through the image display unit 20. When external light passes through the right light guide plate 26 and the left light guide plate 28 from the front of the user and is incident on the user's eye, the image light forming an image and the external light are incident on the user's eye. Therefore, the visibility of the image in the user is influenced by the strength of the external light.

Therefore, it is possible to adjust the easiness of visual recognition of an image, by attaching, for example, a light control plate to the front frame 27 and appropriately selecting or adjusting the optical characteristics of the light control plate. In a typical example, it is possible to select a light control plate having a light transmissive property of an extent that the user wearing the HMD 100 can view at least the outside scene. In addition, it is possible to improve the visibility of the image by suppressing the sunlight. If the light control plate is used, an effect can be expected to protect the right light guide plate 26 and the left light guide plate 28, and reduce the damage of the right light guide plate 26 and the left light guide plate 28, adhesion of dirt thereto, or the like. The light control plate may be detachable to the front frame 27, or the right light guide plate 26 and the left light guide plate 28, respectively. The light control plate may be detachable by exchanging plural types of light control plates, or the light control plate may be omitted.

A camera 61 is disposed in the front frame 27 of the image display unit 20. The camera 61 is provided on the front surface of the front frame 27 at a position not obstructing the external light transmitting the right light guide plate 26 and the left light guide plate 28. In the example of FIG. 1, the camera 61 is disposed on the end portion ER side of the front frame 27. The camera 61 may be disposed on the end portion EL side of the front frame 27, or may be disposed at the connecting portion between the right light guide plate 26 and the left light guide plate 28.

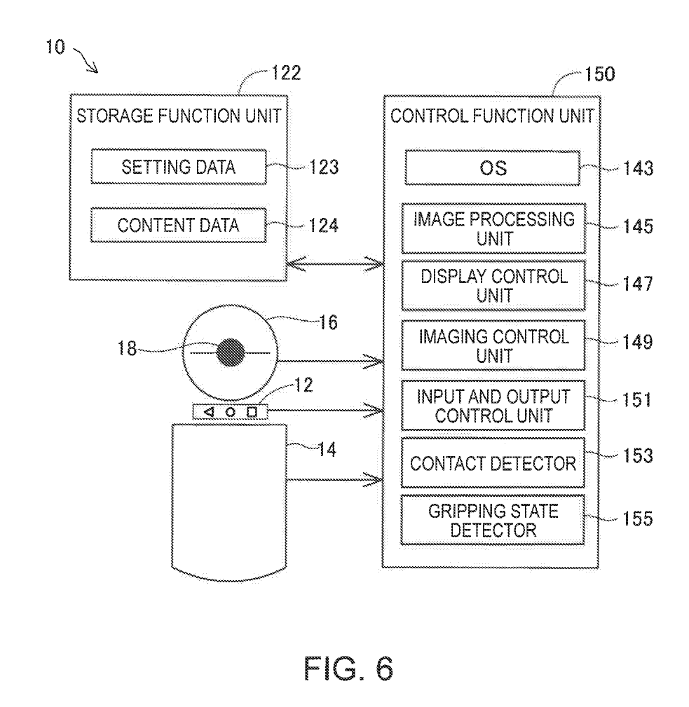

The camera 61 is a digital camera including an image pickup device such as a CCD or a CMOS, an imaging lens, and the like. In the present embodiment, the camera 61 is a monocular camera, but a stereo camera may be adopted. The camera 61 captures an image of at least a portion of an outside world (real space) in the front direction of the HMD 100, in other words, in the view direction viewed by the user, in the state of wearing the image display unit 20. In other words, the camera 61 captures an image in a range or a direction overlapping the field of view of the user, and captures an image in a direction viewed by the user. The size of the angle of view of the camera 61 can be set as appropriate. In the present embodiment, the size of the angle of view of the camera 61 is set such that the image of the entire field of view of the user that can be viewed through the right light guide plate 26 and the left light guide plate 28 is captured. The camera 61 performs imaging and outputs the obtained imaging data to a control function unit 150 under the control of the control function unit 150 (FIG. 6).

The HMD 100 may be equipped with a distance sensor that detects the distance to an object to be measured located in the preset measurement direction. The distance sensor can be disposed at, for example, a connecting portion between the right light guide plate 26 and the left light guide plate 28 of the front frame 27. The measurement direction of the distance sensor can be the front direction of the HMD 100 (the direction overlapping the imaging direction of the camera 61). The distance sensor can be configured with, for example, alight emitting section such as an LED, or a laser diode, and a light receiving section that receives reflected light such that the light emitted from the light source reflects on the object to be measured. In this case, a distance is obtained, by a triangulation distance measurement process, or a distance measurement process based on a time difference. The distance sensor may be configured with, for example, a transmitter that emits ultrasonic waves and a receiver that receives ultrasonic waves reflected by an object to be measured. In this case, a distance is obtained, by a distance measurement process based on a time difference. Similar to the camera 61, the distance sensor measures the distance according to the instruction of the control function unit 150 and outputs the detection result to the control function unit 150.

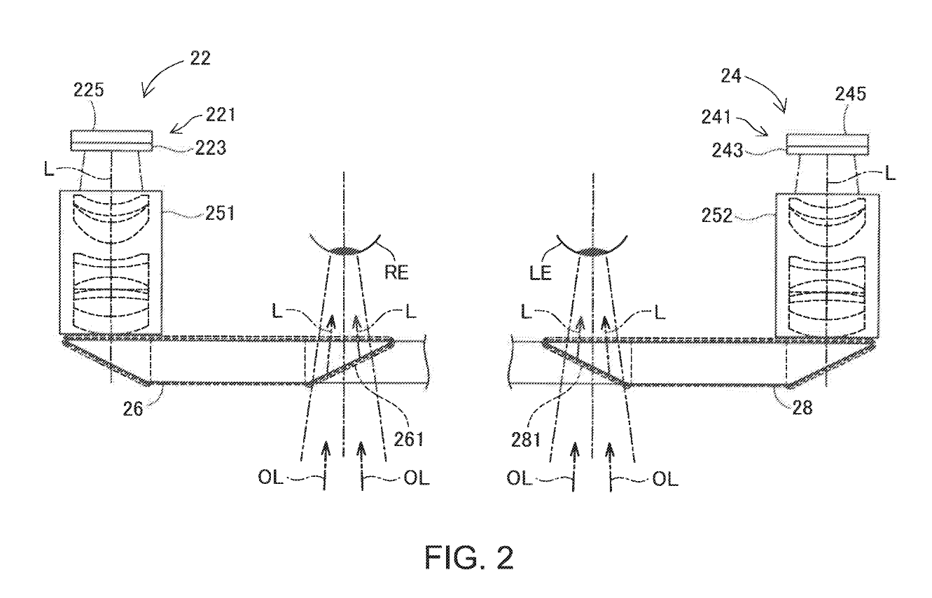

FIG. 2 is a plan view of a main part illustrating a configuration of an optical system included in the image display unit 20. For the convenience of explanation, FIG. 2 illustrates the right eye RE and the left eye LE of the user. As illustrated in FIG. 2, the right display unit 22 and the left display unit 24 are configured symmetrically to the left right.

The right display unit 22 includes an organic light emitting diode (OLED) unit 221 and a right optical system. 251, as a configuration for allowing the right eye RE to view an image (AR image). The OLED unit 221 emits image light. The right optical system 251 includes a lens group, and guides an image light L emitted by the OLED unit 221 to the right light guide plate 26.

The OLED unit 221 includes an OLED panel 223, and an OLED drive circuit 225 that drives the OLED panel 223. The OLED panel 223 is a self-emitting display panel configured with light emitting elements that emit light by organic electroluminescence, and emit color lights of red (R), green (G), and blue (B), respectively. In the OLED panel 223, a plurality of pixels are arranged in a matrix, each pixel having respective one R, G, and B elements.

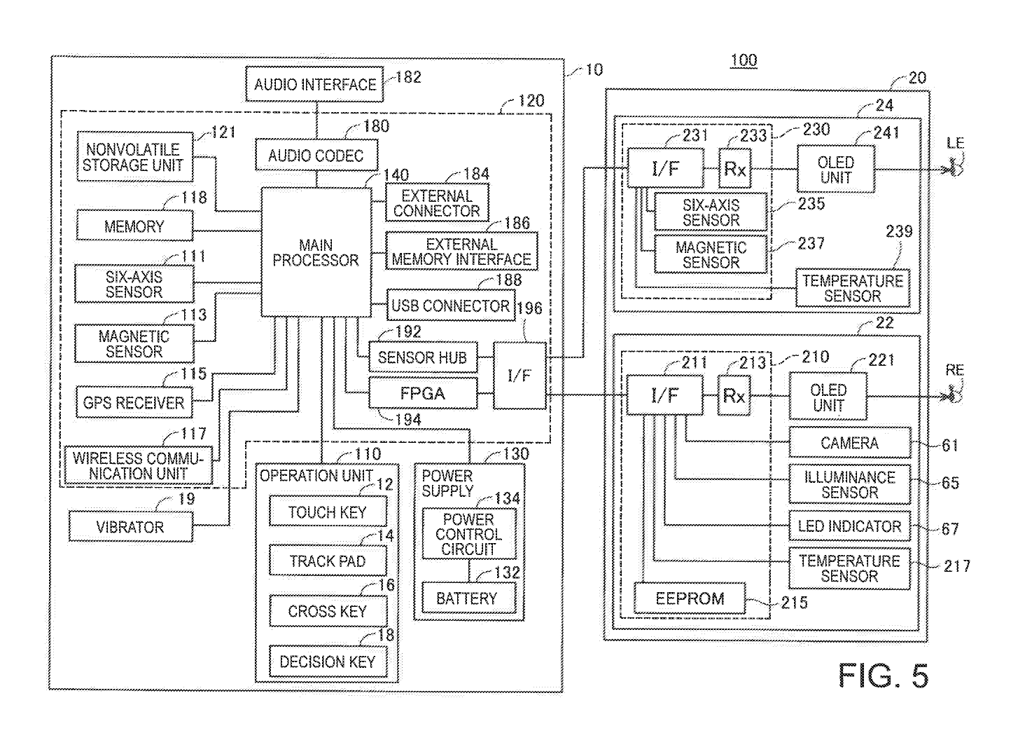

The OLED drive circuit 225 selects light emitting elements included in the OLED panel 223 and supplies power to the light emitting elements under the control of the control function unit 150 to be described later (FIG. 6), and causes the light emitting element to emit light. The OLED drive circuit 225 is fixed to the back surface of the OLED panel 223, that is, the back side of the light emitting surface by bonding or the like. The OLED drive circuit 225 may be configured with, for example, a semiconductor device that drives the OLED panel 223, and may be mounted on the substrate fixed to the back surface of the OLED panel 223. A temperature sensor 217 (FIG. 5) which will be described later is mounted on the substrate. In addition, the OLED panel 223 may have a configuration in which light emitting elements that emit white light are arranged in a matrix and color filters corresponding to the respective colors R, G, and B are superimposed and arranged. The OLED panel 223 having a WRGB configuration may be adopted in which a light emitting element that emits light of W (white) is provided in addition to the light emitting elements that emit respective colors R, G, and B.

The right optical system 251 includes a collimating lens that makes the image light L emitted from the OLED panel 223 into a parallel light flux. The image light L made into the parallel light flux by the collimating lens enters the right light guide plate 26. A plurality of reflective surfaces reflecting the image light L are formed in the light path guiding the light inside the right light guide plate 26. The image light L is guided to the right eye RE side by being subjected to a plurality of reflections inside the right light guide plate 26. A half mirror 261 (reflective surface) located in front of the right eye RE is formed on the right light guide plate 26. After being reflected by the half mirror 261, the image light L is emitted from the right light guide plate 26 to the right eye RE, and this image light L forms an image on the retina of the right eye RE, thereby allowing the user to view the image.

The left display unit 24 includes an OLED unit 241 and a left optical system 252, as a configuration allowing the left eye LE to view an image (AR image). The OLED unit 241 emits image light. The left optical system 252 includes a lens group, and guides the image light L emitted from the OLED unit 241 to the left light guide plate 28. The OLED unit 241 includes an OLED panel 243, and an OLED drive circuit 245 that drives the OLED panel 243. The details of the respective parts are the same as those of the OLED unit 221, the OLED panel 223, and the OLED drive circuit 225. A temperature sensor 239 (FIG. 5) is mounted on the substrate fixed to the back surface of the OLED panel 243. The details of the left optical system 252 are the same as those of the right optical system 251 described above.

According to the above-described configuration, the HMD 100 can function as a see-through type display device. In other words, the image light L reflected by the half mirror 261 and the external light OL passing through the right light guide plate 26 are incident on the user's right eye RE. The image light L reflected by the half mirror 281 and the external light OL passing through the left light guide plate 28 are incident on the user's left eye LE. The HMD 100 causes the image light L of the internally processed image and the external light OL to be superimposed and incident on the eye of the user. As a result, the scenery of an outside world (real world) is visible through the right light guide plate 26 and the left light guide plate 28, and a virtual image (AR image) by the image light L is viewed by the user so as to be superimposed on this outside scene.

The right optical system 251 and the right light guide plate 26 are collectively referred to as “a right light guide portion”, and the left optical system 252 and the left light guide plate 28 are also referred to as “a left light guide portion.” The configurations of the right light guide portion and the left light guide portion are not limited to the above example, and an arbitrary method can be used as long as an image is formed in front of the eye of the user using image light. For example, diffraction gratings may be used, or transflective films may be used, for the right light guide portion and the left light guide portion.

In FIG. 1, the input device 10 and the image display unit 20 are connected by a connection cable 40. The connection cable 40 is detachably connected to a connector provided at the bottom of the input device 10, and is connected from the tip of the left holding unit 23 to various circuits inside the image display unit 20. The connection cable 40 has a metal cable or an optical fiber cable for transmitting digital data. The connection cable 40 may further include a metal cable for transmitting analog data. A connector 46 is provided in the middle of the connection cable 40.

The connector 46 is a jack for connecting a stereo mini plug, and the connector 46 and the input device 10 are connected by, for example, a line for transferring analog audio signals. In the example of the present embodiment illustrated in FIG. 1, a right earphone 32 and a left earphone 34 constituting a stereo headphone and a head set 30 having a microphone 63 are connected to the connector 46.

For example, the microphone 63 is arranged so that the sound pickup portion of the microphone 63 faces the user's line-of-sight direction, as illustrated in FIG. 1. The microphone 63 picks up audio and outputs the audio signal to an audio interface 182 (FIG. 5). The microphone 63 may be a monaural microphone or a stereo microphone, or may be a directional microphone or an omnidirectional microphone.

The input device 10 is a device that controls the HMD 100. The input device 10 includes a track pad 14, a cross key 16, a decision key 18, and a touch key 12. The track pad 14 is an operation unit including an operation surface for receiving a touch operation. The track pad 14 detects a touch operation on the operation surface and outputs a signal corresponding to the detected contents. In this embodiment, the track pad 14 is an electrostatic type track pad. In a contact portion detection process to be described later, a contact portion in the track pad 14 is detected by using an electrostatic sensor (not shown) provided in the track pad 14. Instead of an electrostatic type, various track pads such as a pressure detection type and an optical type may be adopted as the track pad 14. Further, a touch panel having a display function may be adopted as an operation unit including an operation surface for receiving a touch operation. As the touch panel, various touch panels such as a resistive membrane type, an ultrasonic surface acoustic wave type, an infrared optical imaging type, and an electromagnetic induction type can be adopted.

When a depression operation to the key corresponding to each of up, down, right, and left directions of the cross key 16 is detected, a signal corresponding to the detected contents is output. When a depression operation of the decision key 18 is detected, a signal for determining the content operated in the input device 10 is output. The touch key 12 includes three keys from the left in order, a BACK key, a HOME key, and a history key, detects a depression operation to each key, and outputs a signal corresponding to the detected contents. The touch key 12 also functions as a lighting portion. Specifically, the lighting portion notifies of the operation state (for example, power ON/OFF, or the like) of the HMD 100 by its light emission mode. For example, a light emitting diode (LED) can be used as the lighting portion. A power supply switch (not shown) switches the state of the power supply of the HMD 100 by detecting the slide operation of the switch.

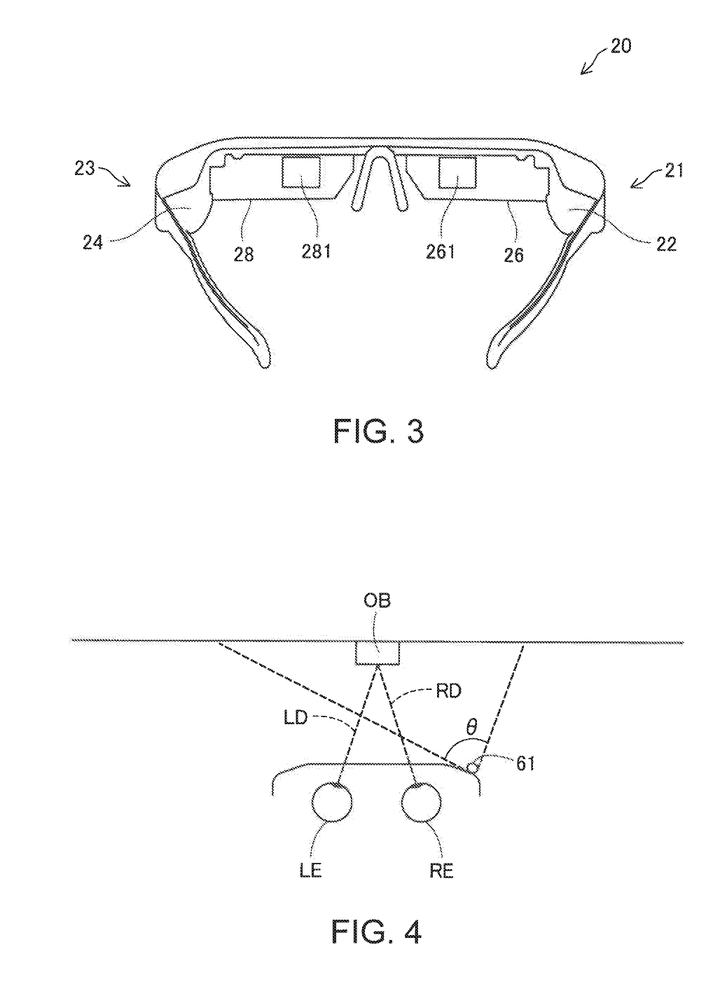

FIG. 3 is a diagram illustrating a configuration of the main parts of the image display unit 20 viewed from the user. In FIG. 3, the illustration of the connection cable 40, the right earphone 32, and the left earphone 34 is omitted. In the state of FIG. 3, the back sides of the right light guide plate 26 and the left light guide plate 28 are visible, and the half mirror 261 illuminating the image light to the right eye RE and the half mirror 281 illuminating the image light to the left eye LE are visible as substantially rectangular areas. The user views the scenery of an outside world through the whole of the right light guide plate 26 and the left light guide plate 28 including the half mirrors 261 and 281, and views a rectangular display image at the positions of the half mirrors 261 and 281.

FIG. 4 is a diagram illustrating an angle of view of the camera 61. In FIG. 4, the camera 61 and the user's right eye RE and left eye LE are schematically illustrated in a plan view, and the angle of view (imaging range) of the camera 61 is denoted by θ. The angle θ of view of the camera 61 extends in the horizontal direction as illustrated in FIG. 4, and also extends in the vertical direction similar to a general digital camera.

As described above, the camera 61 is disposed at the end portion on the right side of the image display unit 20, and captures an image in the line-of-sight direction of the user (that is, the front of the user). Therefore, the optical axis of the camera 61 is in a direction including the line-of-sight directions of the right eye RE and the left eye LE. The scenery of an outside world that the user can view in the state of wearing the HMD 100 is not limited to infinity. For example, when the user gazes at the object OB with both eyes, the line of sight of the user is directed to the object OB as indicated by reference symbols RD and LD in FIG. 4. In this case, the distance from the user to the object OB is likely to be about 30 cm to 10 m, and is more likely to be 1 m to 4 m. Therefore, a measure of the upper limit and the lower limit of the distance from the user to the object OB at the time of normal use may be set for the HMD 100. This measure may be determined in advance and pre-set in the HMD 100, or may be set by the user. It is preferable that the optical axis and the angle of view of the camera 61 are set such that the object OB is included in the angle of view when the distance to the object OB at the time of normal use corresponds to the measure of the upper limit and the lower limit which are set.

In general, the viewing angle of a human being is set to about 200 degrees in the horizontal direction and about 125 degrees in the vertical direction. Among them, the effective visual field with excellent information reception ability is 30 degrees in the horizontal direction and about 20 degrees in the vertical direction. A stable field of fixation in which a gaze point gazed at by humans seems promptly stable is in a range of 60 to 90 degrees in the horizontal direction and 45 to 70 degrees in the vertical direction. In this case, if the gazing point is an object OB (FIG. 4), the effective field of view is about 30 degrees in the horizontal direction and about 20 degrees in the vertical direction with the lines of sight RD and LD as the center. The stable field of fixation is 60 to 90 degrees in the horizontal direction and about 45 to 70 degrees in the vertical direction. The actual field of view that is viewed through the image display unit 20 and then through the right light guide plate 26 and the left light guide plate 28 by users is referred to as the field of view (FOV). The actual field of view is narrower than the viewing angle and stable field of fixation, but wider than the effective field of view.

The angle θ of view of the camera 61 of the present embodiment is set such that a wider range than the user's field of view can be captured. It is preferable that the angle θ of view of the camera 61 is set such that a wider range than at least the user's effective field of view can be captured, and it is more preferable that a wider range than the actual field of view can be captured. It is further preferable that the angle θ of view of the camera 61 is set such that a wider range than the user's stable field of fixation can be captured, and it is most preferable a wider range than the viewing angle of both eyes of the user can be captured. Therefore, a so-called wide-angle lens is provided as an imaging lens in the camera 61, and a configuration may be possible which is capable of capturing a wide angle of view. The wide-angle lens may include a super wide-angle lens and a lens called a quasi-wide-angle lens. Further, the camera 61 may include a single focus lens, may include a zoom lens, or may include a lens group including a plurality of lenses.

FIG. 5 is a block diagram functionally illustrating the configuration of the HMD 100. The input device 10 includes a main processor 140 that controls the HMD 100 by executing a program, a storage unit, an input/output unit, sensors, an interface, and a power supply 130. The storage unit, the input/output unit, the sensors, the interface, and the power supply 130 are respectively connected to the main processor 140. The main processor 140 is mounted on a controller substrate 120 including the built-in input device 10.

The storage unit includes a memory 118 and a nonvolatile storage unit 121. The memory 118 forms a work area for temporarily storing the computer program executed by the main processor 140, and data to be processed. The nonvolatile storage unit 121 is configured with a flash memory or an embedded multi media card (eMMC). The nonvolatile storage unit 121 stores the computer program executed by the main processor 140 and various data processed by the main processor 140. In the present embodiment, these storage units are mounted on the controller substrate 120.

The input/output unit includes an operation unit 110. There are a plurality of operation units 110 such as the touch key 12, the track pad 14, the cross key 16, the decision key 18, and a power switch (not shown). The main processor 140 controls each input/output unit, and acquires a signal output from each input/output unit. More specifically, each input/output unit outputs a digital signal, and the main processor 140 acquires the digital signal output from each input/output unit. Further, for example, each input/output unit may output an analog signal, and the main processor 140 may acquire a digital signal by performing AD conversion on an analog signal output from each input/output unit.

The sensors include a six-axis sensor 111, a magnetic sensor 113, and a global positioning system (GPS) receiver 115. The six-axis sensor 111 is a motion sensor (inertial sensor) equipped with a three-axis acceleration sensor and a three-axis gyro (angular velocity) sensor. The six-axis sensor 111 may adopt an inertial measurement unit (IMU) in which these sensors are modularized. The magnetic sensor 113 is, for example, a three-axis geomagnetic sensor. The GPS receiver 115 includes a GPS antenna not illustrated, receives radio signals transmitted from the GPS satellite, and detects the coordinates of the current position of the input device 10. The sensors (the six-axis sensor 111, the magnetic sensor 113, and the GPS receiver 115) output the detection value to the main processor 140 according to the sampling frequency designated in advance. The timing at which each sensor outputs the detection value may be determined according to an instruction from the main processor 140.

Interfaces include a wireless communication unit 117, an audio codec 180, an external connector 184, an external memory interface 186, a universal serial bus (USB) connector 188, a sensor hub 192, an FPGA 194, and an interface 196. They function as interfaces with the outside.

The wireless communication unit 117 performs wireless communication between the HMD 100 and the external device. The wireless communication unit 117 is configured with an antenna, an RF circuit, a baseband circuit, a communication control circuit, and the like, not illustrated, or is configured as a device in which these are integrated. The wireless communication unit 117 performs wireless communication conforming to the standards of a wireless LAN including, for example, Bluetooth (registered trademark), Wi-Fi (registered trademark), or the like.

The audio codec 180 is connected to the audio interface 182, and encodes/decodes an audio signal which is input/output through the audio interface 182. The audio interface 182 is an interface that inputs and outputs an audio signal. The audio codec 180 may include an A/D converter that converts an analog audio signal to digital audio data, and a D/A converter that performs the reverse conversion thereof. The HMD 100 of the present embodiment outputs audio from the right earphone 32 and the left earphone 34, and collects it by the microphone 63. The audio codec 180 converts a digital audio data output by the main processor 140 into an analog audio signal, and outputs it through the audio interface 182. The audio codec 180 converts an analog audio signal input to the audio interface 182 into digital audio data, and outputs it to the main processor 140.

The external connector 184 is a connector for connecting an external device (for example, a personal computer, a smart phone, a game machine, or the like) that communicates with the main processor 140, to the main processor 140. The external device connected to the external connector 184 can serve as a source of contents, and as well as can be used for debugging the computer program executed by the main processor 140, or for collecting operation logs of the HMD 100. The external connector 184 can adopt various aspects. The external connector 184 can adopt, for example, an interface corresponding to wired connection such as a USB interface, a micro-USB interface, and a memory card interface, or an interface corresponding to the wireless connection such as a wireless LAN interface, or a Bluetooth interface.

The external memory interface 186 is an interface to which a portable memory device can be connected. The external memory interface 186 includes, for example, a memory card slot loaded with a card type recording medium for reading and writing data, and an interface circuit. The size, shape, standard, or the like of the card-type recording medium can be appropriately selected. The USB connector 188 is an interface for connecting a memory device, a smart phone, a personal computer, or the like, conforming to the USB standard. The USB connector 188 includes, for example, a connector conforming to the USB standard, and an interface circuit. The size and shape of the USB connector 188, the version of the USB standard, or the like can be selected as appropriate.

The HMD 100 also includes a vibrator 19. The vibrator 19 includes a motor which is not illustrated, an eccentric rotor, and the like, and generates vibrations under the control of the main processor 140. The HMD 100 generates vibration with a predetermined vibration pattern by the vibrator 19, for example, in a case where an operation on the operation unit 110 is detected, in a case where the power of the HMD 100 is turned on or off, or the like.

The sensor hub 192 and the FPGA 194 are connected to the image display unit 20 through the interface (I/F) 196. The sensor hub 192 acquires the detection values of the various sensors provided in the image display unit 20, and outputs them to the main processor 140. The FPGA 194 processes data transmitted and received between the main processor 140 and each part of the image display unit 20 and transfers it through the interface 196. The interface 196 is connected to the right display unit 22 and the left display unit 24 of the image display unit 20, respectively. In the example of the present embodiment, the connection cable 40 is connected to the left holding unit 23, and the wiring linked to the connection cable 40 is laid in the inside of the image display unit 20, the right display unit 22 and the left display unit 24 are connected to the interface 196 of the input device 10, respectively.

The power supply 130 includes a battery 132, and a power control circuit 134. The power supply 130 provides power to operate the input device 10. The battery 132 is a rechargeable battery. The power control circuit 134 detects the remaining capacity of the battery 132 and controls the charging to an OS 143 (FIG. 6). The power control circuit 134 is connected to the main processor 140, and outputs the detection value of the remaining capacity of the battery 132 and the detection value of the voltage of the battery 132 to the main processor 140. Power may be supplied from the input device 10 to the image display unit 20, based on the electric power supplied by the power supply 130. It may be configured such that the state of the supply of power from the power supply 130 to each part of the input device 10 and the image display unit 20 is controlled by the main processor 140.

The right display unit 22 includes a display unit substrate 210, the OLED unit 221, the camera 61, an illuminance sensor 65, an LED indicator 67, and the temperature sensor 217. An interface (I/F) 211 connected to the interface 196, a receiver (Rx) 213, and an electrically erasable programmable read-only memory (EEPROM) 215 are mounted on the display unit substrate 210. The receiver 213 receives data input from the input device 10 through the interface 211. When receiving the image data of the image displayed by the OLED unit 221, the receiver 213 outputs the received image data to the OLED drive circuit 225 (FIG. 2).

The EEPROM 215 stores various types of data in such a manner that the main processor 140 can read the data. The EEPROM 215 stores, for example, data about the light emission characteristics and the display characteristics of the OLED units 221 and 241 of the image display unit 20, data about the sensor characteristics of the right display unit 22 and the left display unit 24, and the like. Specifically, it stores, for example, parameters relating to gamma correction of the OLED units 221 and 241, data for compensating the detection values of the temperature sensors 217 and 239 to be described later, and the like. These data are generated by factory shipment inspection of the HMD 100 and written in the EEPROM 215. After shipment, the main processor 140 reads the data in the EEPROM 215 and uses it for various processes.

The camera 61 implements imaging according to the signal input through the interface 211, and outputs captured image data or a signal indicating an imaging result to the input device 10. As illustrated in FIG. 1, the illuminance sensor 65 is provided at the end portion ER of the front frame 27, and is disposed to receive external light from the front of the user wearing the image display unit 20. The illuminance sensor 65 outputs a detection value corresponding to the amount of received light (received light intensity). As illustrated in FIG. 1, the LED indicator 67 is disposed in the vicinity of the camera 61 at the end portion ER of the front frame 27. The LED indicator 67 is lit up during imaging by the camera 61 and notifies that the image is being captured.

The temperature sensor 217 detects the temperature and outputs a voltage value or a resistance value corresponding to the detected temperature. The temperature sensor 217 is mounted on the back side of the OLED panel 223 (FIG. 2). The temperature sensor 217 may be mounted on, for example, the same substrate as that of the OLED drive circuit 225. With this configuration, the temperature sensor 217 mainly detects the temperature of the OLED panel 223. The temperature sensor 217 may be incorporated in the OLED panel 223 or the OLED drive circuit 225 (FIG. 2). When the OLED panel 223 is, for example, a Si-OLED, and the OLED panel 223 and the OLED drive circuit 225 are mounted as an integrated circuit on an integrated semiconductor chip, the temperature sensor 217 may be mounted on the semiconductor chip.

The left display unit 24 includes a display unit substrate 230, the OLED unit 241, and the temperature sensor 239. An interface (I/F) 231 connected to the interface 196, a receiver (Rx) 233, a six-axis sensor 235, and a magnetic sensor 237 are mounted on the display unit substrate 230. The receiver 233 receives data input from the input device 10 through the interface 231. When receiving the image data of the image displayed by the OLED unit 241, the receiver 233 outputs the received image data to the OLED drive circuit 245 (FIG. 2).

The six-axis sensor 235 is a motion sensor (inertial sensor) equipped with a three-axis acceleration sensor and a three-axis gyro (angular velocity) sensor. An IMU in which the above sensors are modularized may be adopted as the six-axis sensor 235. The magnetic sensor 237 is, for example, a three-axis geomagnetic sensor. Since the six-axis sensor 235 and the magnetic sensor 237 are provided in the image display unit 20, when the image display unit 20 is mounted on the head of the user, the movement of the head of the user is detected. The direction of the image display unit 20, that is, the field of view of the user is specified based on the detected movement of the head.

The temperature sensor 239 detects the temperature and outputs a voltage value or a resistance value corresponding to the detected temperature. The temperature sensor 239 is mounted on the back side of the OLED panel 243 (FIG. 2). The temperature sensor 239 may be mounted on, for example, the same substrate as that of the OLED drive circuit 245. With this configuration, the temperature sensor 239 mainly detects the temperature of the OLED panel 243. The temperature sensor 239 may be incorporated in the OLED panel 243 or the OLED drive circuit 245 (FIG. 2). The details are the same as those of the temperature sensor 217.

The camera 61, the illuminance sensor 65, and the temperature sensor 217 of the right display unit 22, and the six-axis sensor 235, the magnetic sensor 237, and the temperature sensor 239 of the left display unit 24 are connected to the sensor hub 192 of the input device 10. The sensor hub 192 sets and initializes the sampling period of each sensor under the control of the main processor 140. The sensor hub 192 supplies power to each sensor, transmits control data, acquires a detection value, or the like, according to the sampling period of each sensor. The sensor hub 192 outputs the detection value of each sensor provided in the right display unit 22 and the left display unit 24 to the main processor 140 at a preset timing. The sensor hub 192 may be provided with a cache function of temporarily holding the detection value of each sensor. The sensor hub 192 may be provided with a conversion function of a signal format or a data format of the detection value of each sensor (for example, a conversion function into a unified format). The sensor hub 192 starts or stops supply of power to the LED indicator 67 under the control of the main processor 140 to turn on or off the LED indicator 67.

FIG. 6 is a block diagram functionally illustrating a configuration of the input device 10. The input device 10 functionally includes a storage function unit 122, and the control function unit 150. The storage function unit 122 is a logical storage unit configured with the nonvolatile storage unit 121 (FIG. 5). Instead of the configuration of only using the storage function unit 122, a configuration may be possible such that the storage function unit 122 is combined with the nonvolatile storage unit 121, and the EEPROM 215 or the memory 118 is used. The control function unit 150 is configured by the main processor 140 executing a computer program, that is, by cooperation of hardware and software.

The storage function unit 122 stores various data to be processed in the control function unit 150. Specifically, setting data 123 and content data 124 are stored in the storage function unit 122 of the present embodiment. The setting data 123 includes various setting values related to the operation of the HMD 100. For example, the setting data 123 includes parameters, a determinant, an arithmetic expression, and a look up table (LUT) when the control function unit 150 controls the HMD 100.

The content data 124 includes data (image data, video data, audio data, or the like) of contents including image and video displayed by the image display unit 20 under the control of the control function unit 150. Data of bidirectional type content may be included in the content data 124. The bidirectional type content means a content of a type in which the operation of the user is acquired by the operation unit 110, the process corresponding to the acquired operation content is performed by the control function unit 150, and content corresponding to the processed content is displayed on the image display unit 20. In this case, content data includes image data of a menu screen for acquiring user's operation, data defining a process corresponding to items included in the menu screen, and the like.

The control function unit 150 executes functions as the operating system (OS) 143, an image processing unit 145, a display control unit 147, an imaging control unit 149, an input and output control unit 151, a contact detector 153, and a gripping state detector 155, by executing various processes using the data stored in the storage function unit 122. In the present embodiment, each functional unit other than the OS 143 is configured as a computer program executed on the OS 143.

The image processing unit 145 generates signals to be transmitted to the right display unit 22 and the left display unit 24, based on an image/image data of video displayed by the image display unit 20. The signals generated by the image processing unit 145 may be a vertical sync signal, a horizontal sync signal, a clock signal, an analog image signal, and the like. The image processing unit 145 may be configured with hardware (for example, a digital signal processor (DSP)) other than the main processor 140, in addition to the configuration realized by the main processor 140 executing the computer program.

The image processing unit 145 may execute a resolution conversion process, an image adjustment process, a 2D/3D conversion process, or the like, as necessary. The resolution conversion process is a process of converting the resolution of the image data into a resolution suitable for the right display unit 22 and the left display unit 24. The image adjustment process is a process of adjusting the brightness and saturation of image data. The 2D/3D conversion process is a process of generating two-dimensional image data from three-dimensional image data, or generating three-dimensional image data from two-dimensional image data. When executing these processes, the image processing unit 145 generates a signal for displaying an image based on the processed image data, and transmits it to the image display unit 20 through the connection cable 40.

The display control unit 147 generates a control signal for controlling the right display unit 22 and the left display unit 24, and controls the generation and emission of image light by each of the right display unit 22 and the left display unit 24, according to this control signal. Specifically, the display control unit 147 controls the OLED drive circuits 225 and 245 so as to display images by the OLED panels 223 and 243. The display control unit 147 controls the timing at which the OLED drive circuits 225 and 245 perform drawing on the OLED panels 223 and 243, and controls the brightness of the OLED panels 223 and 243, based on the signal output from the image processing unit 145.

The display control unit 147 causes the image display unit 20 to display a notification in a case where there is an input to be invalidated in the contact portion of the track pad 14, in the input receiving process to be described later. The details of the input receiving process and the notification display will be described later.

The imaging control unit 149 controls the camera 61 so as to perform imaging, generates captured image data, and temporarily stores it in the storage function unit 122. If the camera 61 is configured with a camera unit including a circuit that generates captured image data, the imaging control unit 149 acquires the captured image data from the camera 61 and temporarily stores it in the storage function unit 122.

The input and output control unit 151 appropriately controls the track pad 14, the cross key 16, the decision key 18 and the like of the operation unit 110, and acquires input commands from them. The acquired command is output to the OS 143, or the OS 143 and the computer program running on the OS 143. The input and output control unit 151 invalidates the input from the contact portion determined according to the gripping state of the input device 10, among the contact portions on the operation surface of the track pad 14, in the input receiving process to be described later. The details of the input receiving process will be described later. It should be noted that the input and output control unit 151 corresponds to a control unit which is means for solving the problem.

The contact detector 153 detects a contact portion in the track pad 14, in a contact portion detection process to be described later. The contact portion corresponds to, for example, a portion where a user's finger (a fingertip or a base of a finger) is in contact with the track pad 14 and a portion where the tip of the stylus pen is in contact with the track pad 14. The details of the contact portion detection process and the contact portion will be described later.

The gripping state detector 155 detects the gripping state of the input device 10 based on the detected contact portion in a gripping state detection process to be described later. In the present embodiment, “gripping state” means a state in which the direction of the input device 10 and the holding method of the input device 10 are associated. The details of the gripping state and the gripping state detection process of the input device 10 will be described later.

### A2. Gripping State of Input Device:

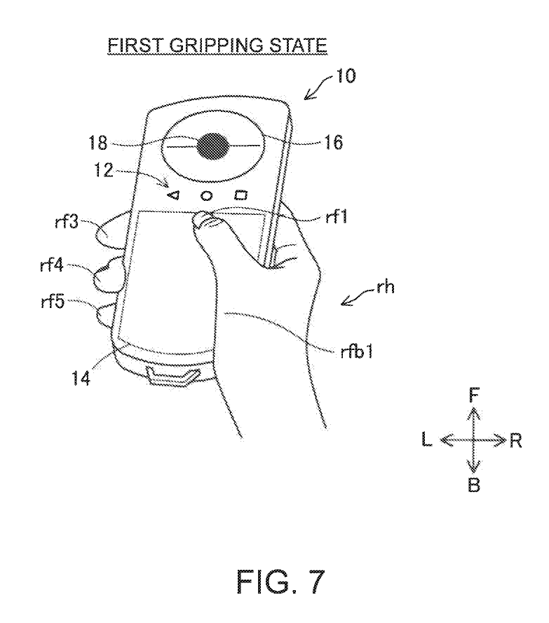

FIG. 7 is an explanatory diagram schematically illustrating a first gripping state of the input device 10. In FIG. 7, “F” indicates the forward direction of the user, “B” indicates the backward direction of the user, “L” indicates the left direction of the user, and “R” indicates the right direction of the user. This also applies to the following description. As illustrated in FIG. 7, the first gripping state is a gripping state where the input device 10 in the vertical direction is supported and operated only with the right hand rh. In the present embodiment, supporting the input device 10 in a vertical direction state may be referred to as “vertical holding”. In other words, the “vertical holding” means that the input device 10 is supported so that the longitudinal direction of the input device 10 is parallel to a direction (for example, a vertical direction) orthogonal to the left and right direction as seen from the user. Not only a case where the longitudinal direction of the input device 10 is perfectly parallel to a direction orthogonal to the left and right direction but also a support state in which the angle formed by the longitudinal direction of the input device 10 and a direction orthogonal to the left and right direction is equal to or less than a predetermined angle may be also referred to as “vertical holding”. In the first gripping state, the input device 10 is gripped by a right thumb base rfb1, a right middle finger rf3, a right ring finger rf4, and a right little finger rf5. Although not shown, the back side of the input device 10 is supported by the right index finger. Further, the input device 10 is operated by a right thumb rf1 of a right hand rh which is a holding hand. In other words, in the input device 10, input is made when the operation surface of the track pad 14 is touched with the right thumb rf1.

In the first gripping state, in the contact portion detection process to be described later, parts of the track pad 14 in contact with the right thumb base rfb1, the right middle finger rf3, the right ring finger rf4, the right little finger rf5, and the right thumb rf1 can be detected as contact portions, respectively.

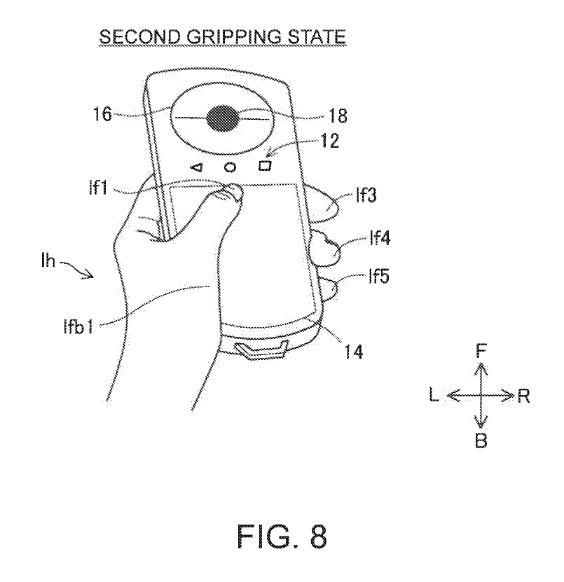

FIG. 8 is an explanatory diagram schematically illustrating a second gripping state of the input device 10. As illustrated in FIG. 8, the second gripping state is a gripping state where the input device 10 in the vertical direction is supported and operated only with a left hand lh. In other words, the second gripping state is different from the first gripping state illustrated in FIG. 7 in that the hand holding the input device 10 is the left hand lh instead of the right hand rh. In the second gripping state, the input device 10 is gripped by a left thumb base lfb1, a left middle finger lf3, a left ring finger lf4, and a left little finger lf5. Although not shown, the back side of the input device 10 is supported by the left index finger. Further, the input device 10 is operated by a left thumb lf1 of the left hand lh which is a holding hand. In other words, in the input device 10, input is made when the operation surface of the track pad 14 is touched with the left thumb lf1.

In the second gripping state, in the contact portion detection process to be described later, parts of the track pad 14 in contact with the left thumb base lfb1, the left middle finger lf3, the left ring finger lf4, the left little finger lf5, and the left thumb lf1 can be detected as contact portions, respectively. In the following description, a gripping state in which the input device 10 is supported and operated with one hand as in the first gripping state and the second gripping state is referred to as “one hand holding”.

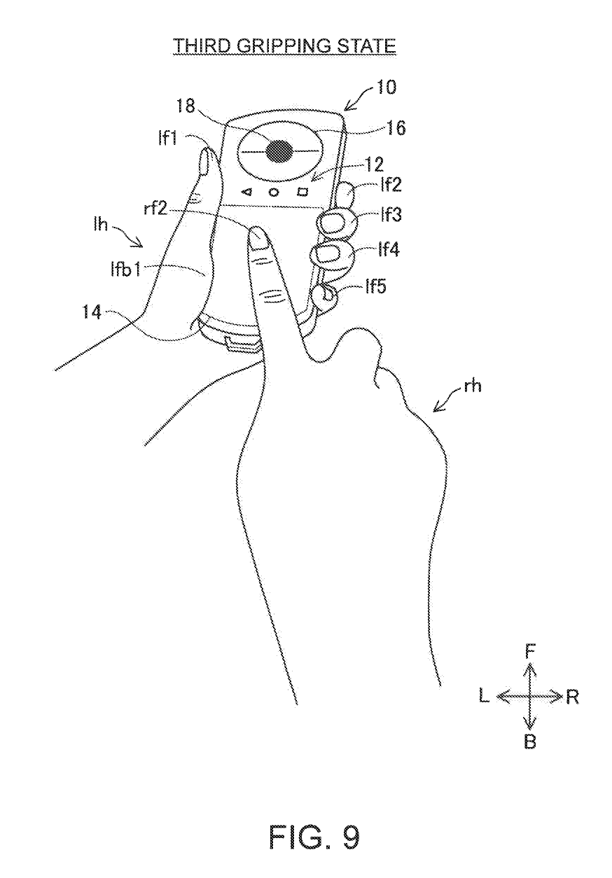

FIG. 9 is an explanatory diagram schematically illustrating a third gripping state of the input device 10. As illustrated in FIG. 9, the third gripping state is a gripping state in which the input device 10 in the vertical direction is supported by the left hand lh and the input device 10 is operated with the right hand rh. In the third gripping state, the input device 10 is gripped by the left thumb base lfb1, the left thumb lf1, a left index finger lf2, the left middle finger lf3, the left ring finger lf4, and the left little finger lf5. Further, the input device 10 is operated by a right index finger rf2 of the right hand rh which is the hand opposite to the holding hand (left hand lh). In other words, in the input device 10, input is made when the operation surface of the track pad 14 is touched with the right index finger rf2.

In the third gripping state, in the contact portion detection process to be described later, parts of the track pad 14 in contact with the left thumb base lfb1, the left thumb lf1, the left index finger lf2, the left middle finger lf3, the left ring finger lf4, the left little finger lf5, and the right index finger rf2 can be detected as contact portions, respectively.

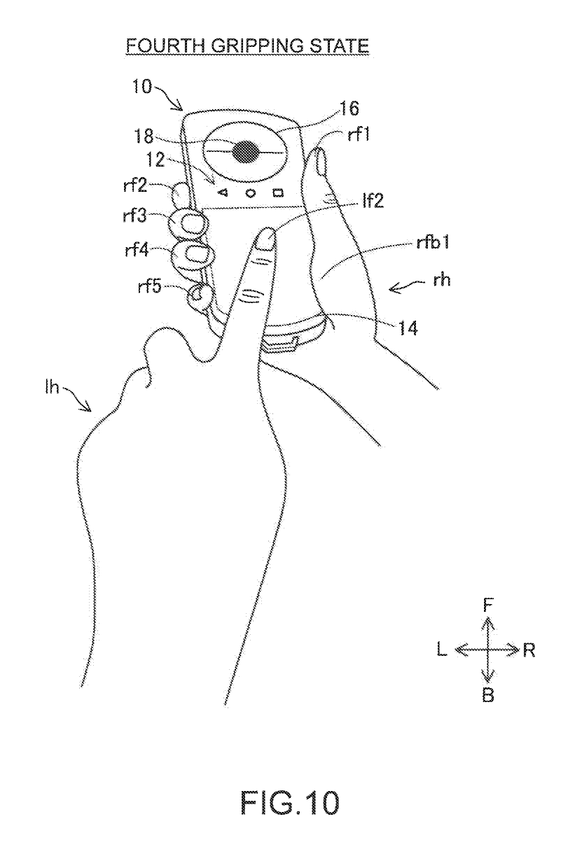

FIG. 10 is an explanatory diagram schematically illustrating a fourth gripping state of the input device 10. As illustrated in FIG. 10, the fourth gripping state is a gripping state in which the input device 10 in the vertical direction is supported by the right hand rh and the input device 10 is operated with the left hand lh. In other words, the fourth gripping state is different from the third gripping state illustrated in FIG. 9 in that the hand holding the input device 10 is the right hand rh instead of the left hand lh and the hand operating the input device 10 is the left hand lh instead of the right hand rh. As illustrated in FIG. 10, in the fourth gripping state, the input device 10 is gripped by the right thumb base rfb1, the right thumb rf1, the right index finger rf2, the right middle finger rf3, the right ring finger rf4, and the right little finger rf5. Further, the input device 10 is operated by the left index finger lf2 of the left hand lh, which is the hand opposite to the holding hand (right hand rh). In other words, in the input device 10, input is made when the operation surface of the track pad 14 is touched with the left index finger lf2.

In the fourth gripping state, in the contact portion detection process to be described later, parts of the track pad 14 in contact with the right thumb base rfb1, the right thumb rf1, the right index finger rf2, the right middle finger rf3, the right ring finger rf4, the right little finger rf5, and the left index finger lf2 can be detected as contact portions, respectively. In the following description, a gripping state in which support and operation of the input device 10 are performed with different hands respectively as in the third gripping state and the fourth gripping state is referred to as “both hands holding”.

As can be understood by comparing FIG. 8 with FIG. 9, and FIG. 7 with FIG. 10, in one hand holding illustrated in FIGS. 7 and 8 and both hands holding illustrated in FIGS. 9 and 10, even if the holding hand is the same, the number, the position and the area of the contact portions are different from each other. For example, in the case where the hand holding the input device 10 is the right hand, the number of contact portions on the right side of the track pad 14 is two: a contact portion with the finger tip of the right thumb rf1 and a contact portion with the right thumb base rfb1, in the one hand holding illustrated in FIG. 7. On the other hand, in the both hands holding illustrated in FIG. 10, the number of contact portions is one: a contact portion with the right thumb base rfb1. Further, for example, the position of the contact portion by the right thumb base rfb1 is the position on the lower right side of the track pad 14 in the one hand holding illustrated in FIG. 7. On the other hand, in the both hands holding illustrated in FIG. 10, it is a position along the right side surface of the track pad 14. Further, for example, the area of the contact portion by the right thumb base rfb1 is the area of a predetermined region on the lower right side of the track pad 14 in the one hand holding illustrated in FIG. 7. On the other hand, in the both hands holding illustrated in FIG. 10, it is the area of the region continuing from the upper right side to the lower right side of the track pad 14.

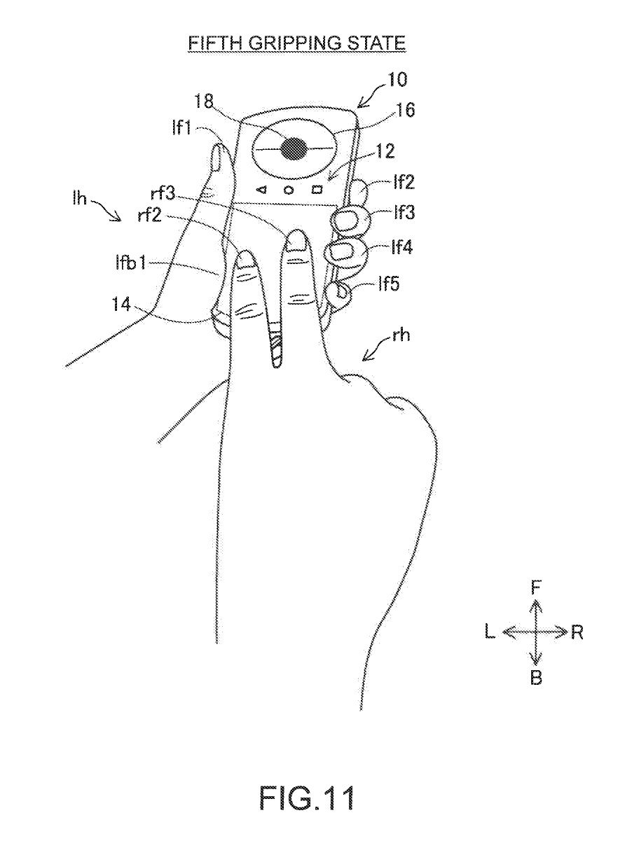

FIG. 11 is an explanatory diagram schematically illustrating a fifth gripping state of the input device 10. As illustrated in FIG. 11, the fifth gripping state is a gripping state in which the input device 10 in the vertical direction is supported by the left hand lh and the input device 10 is operated with the right hand rh. It is different from the third gripping state illustrated in FIG. 9 in that the right middle finger rf3 is added as a finger operating the input device 10. In the fifth gripping state, the input device 10 is operated by the right index finger rf2 and the right middle finger rf3 of the right hand rh which is the hand opposite to the holding hand (left hand lh). In other words, in the input device 10, input is made when the operation surface of the track pad 14 is touched with the right index finger rf2 or the right middle finger rf3. In the fifth gripping state, it is possible to perform a gesture input (so-called pinch-in/pinch out or the like) by multi-touch using the right index finger rf2 and the right middle finger rf3.

In the fifth gripping state, in the contact portion detection process to be described later, parts of the track pad 14 in contact with the left thumb base lfb1, the left thumb lf1, the left index finger lf2, the left middle finger lf3, the left ring finger lf4, the left little finger lf5, the right index finger rf2, and the right middle finger rf3 can be detected as contact portions, respectively.

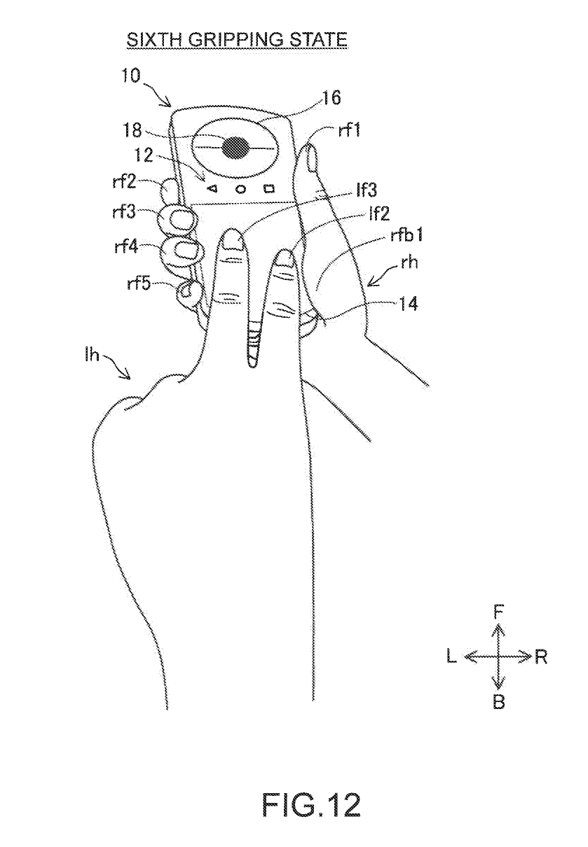

FIG. 12 is an explanatory diagram schematically illustrating a sixth gripping state of the input device 10. As illustrated in FIG. 12, the sixth gripping state is a gripping state in which the input device 10 in the vertical direction is supported by the right hand rh and the input device 10 is operated with the left hand lh. It is different from the fourth gripping state illustrated in FIG. 10 in that the left middle finger lf3 is added as a finger operating the input device 10. In the sixth gripping state, the input device 10 is operated by the left index finger lf2 and the left middle finger lf3 of the left hand lh which is the hand opposite to the holding hand (right hand rh). In other words, in the input device 10, input is made when the operation surface of the track pad 14 is touched with the left index finger lf2 or the left middle finger lf3.

In the sixth gripping state, in the contact portion detection process to be described later, parts of the track pad 14 in contact with the right thumb base rfb1, the right thumb rf1, the right index finger rf2, the right middle finger rf3, the right ring finger rf4, the right little finger rf5, the left index finger lf2, and the left middle finger lf3 can be detected as contact portions, respectively.

As can be understood by comparing FIG. 9 with FIG. 10, and FIG. 11 with FIG. 12, in the case of both hands holding, there are a gripping state in which the total number of contact portions excluding contact portions by a finger operating the input device 10, that is, contact portions by a finger or a base of a finger supporting the input device 10 (hereinafter referred to as “support contact portion”) is one, and a gripping state in which the total number is two. In the present embodiment, a case where the total number of contact portions excluding the support contact portion is one is assumed to be “single-touch”. On the other hand, a case where the total number of contact portions excluding the support contact portion is two is assumed to be “multi-touch”. In the gripping state detection process to be described later, it is distinguished between single-touch and multi-touch by specifying the support contact portion of the detected contact portions and detecting the total number of contact portions excluding the specified support contact portion.

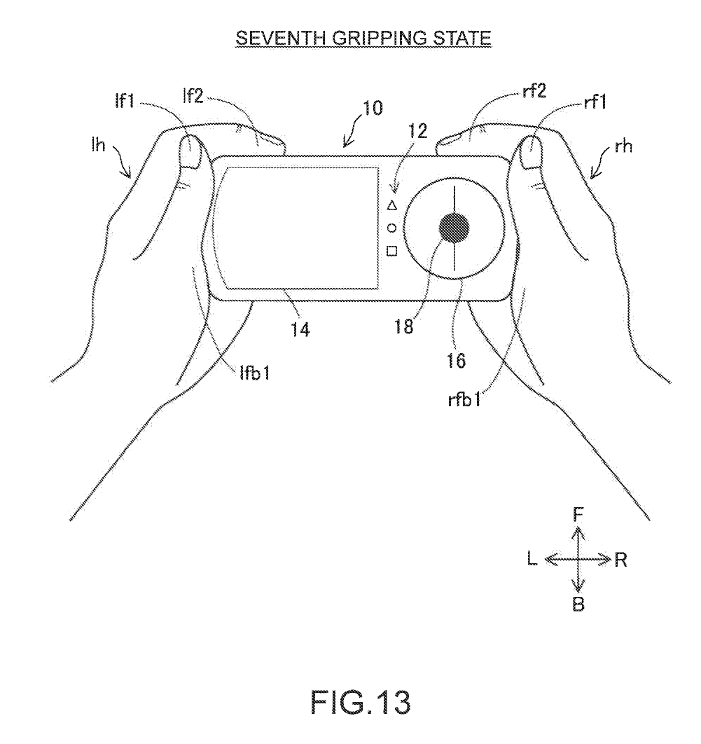

FIG. 13 is an explanatory diagram schematically illustrating a seventh gripping state of the input device 10. As illustrated in FIG. 13, the seventh gripping state is a gripping state in which the input device 10 in the horizontal direction is supported by both hands and the track pad 14 is touched by the left hand lh. In the present embodiment, supporting the input device 10 in the horizontal direction state is referred to as “horizontal holding”. In other words, the “horizontal holding” means that the input device 10 is supported so that the longitudinal direction of the input device 10 is parallel to the left and right direction as seen from the user. Not only a case where the longitudinal direction of the input device 10 is perfectly parallel to the left and right direction but also a support state in which the angle formed by the longitudinal direction of the input device 10 and the left and right direction is equal to or less than a predetermined angle may also be referred to as “horizontal holding”. In the seventh gripping state, in the input device 10, the cross key 16 side is gripped by the right hand rh and the track pad 14 side is gripped by the left hand lh. Further, the track pad 14 is operated by the left thumb lf1. In other words, in the input device 10, input is made when the operation surface of the track pad 14 is touched with the left thumb lf1.

In the seventh gripping state, in the contact portion detection process to be described later, parts of the track pad 14 in contact with the left thumb base lfb1 and the left thumb lf1 can be detected as contact portions, respectively.

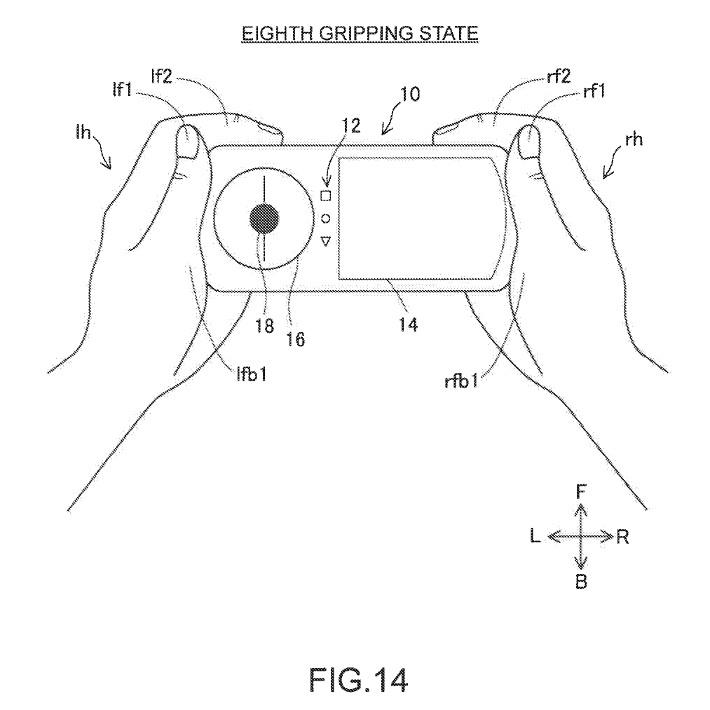

FIG. 14 is an explanatory diagram schematically illustrating an eighth gripping state of the input device 10. As illustrated in FIG. 14, the eighth gripping state is a gripping state in which the input device 10 in the horizontal direction is supported by both hands and the track pad 14 is touched by the right hand rh. It is different from the seventh gripping state illustrated in FIG. 13 in that the direction of the input device 10 is opposite and the finger operating the track pad 14 is the right thumb rf1 instead of the left thumb lf1. In the eighth gripping state, the track pad 14 is operated by the right thumb rf1. In other words, in the input device 10, input is made when the operation surface of the track pad 14 is touched with the right thumb rf1.

In the eighth gripping state, in the contact portion detection process to be described later, parts of the track pad 14 in contact with the right thumb base rfb1 and the right thumb rf1 can be detected as contact portions, respectively.

As described above, the number, the positions, the areas, and the like of the contact portions are different due to the difference in the gripping state of the input device 10. In each gripping state, a fingertip for operation, for example, a fingertip or a base of a finger other than the right thumb rf1 in the first gripping state illustrated in FIG. 7 touches the operation surface of the track pad 14, resulting in erroneous input. That is, in the track pad 14, due to unexpected contact, a contact portion different from the contact portion for operation may be generated. The position or size of the contact portion (hereinafter referred to as “non-purpose contact portion”) which is the source of the unexpected erroneous input differs depending on the gripping state. Therefore, in the input device 10 of the present embodiment, in the input receiving process to be described later, the gripping state is specified, the input from the contact portion determined according to the specified gripping state is invalidated, and the input is received.

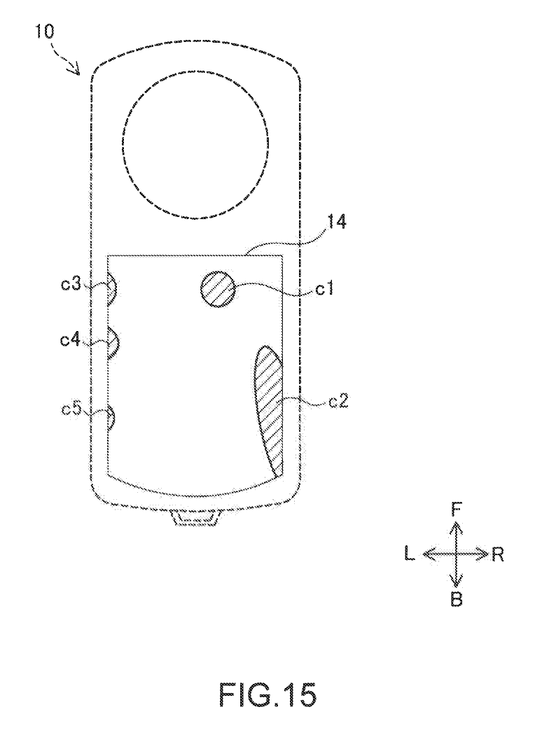

FIG. 15 is an explanatory diagram schematically illustrating an example of a contact portion detected in the first gripping state. A contact portion c1 is a contact portion with the thumb rf1 as a finger for operation. All of the other contact portions c2 to c5 are contact portions of a finger or a base of a finger different from the finger for operation. In this case, in the input receiving process to be described later, the input from the other contact portions c2 to c5 excluding the contact portion c1 is invalidated, in other words, only the input from the contact portion c1 is validated and the input to the track pad 14 is received.

### A3. Input Receiving Process:

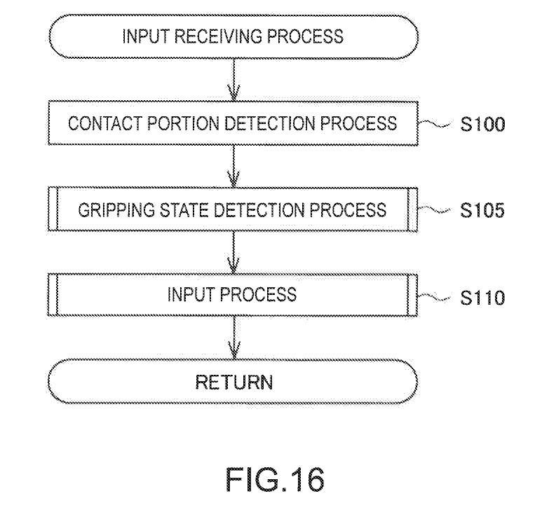

FIG. 16 is a flowchart illustrating the procedure of an input receiving process. The input receiving process is started when the user sets the power switch of the input device 10 to ON. As illustrated in FIG. 16, the contact detector 153 executes the contact portion detection process (step S100). Specifically, a contact portion in the track pad 14 is detected by using an electrostatic sensor (not shown) provided in the track pad 14. The contact detector 153 detects the number, the position (coordinates) and the area of the contact portions, using the detection result of the electrostatic sensor. In the present embodiment, the “position (coordinates) of the contact portion” means any one of the coordinates included in the contact portion, the respective coordinates constituting the contour of the contact portion, and the coordinates of the position of the center of gravity of the contact portion. After execution of step S100, the gripping state detector 155 executes the gripping state detection process (step S105).

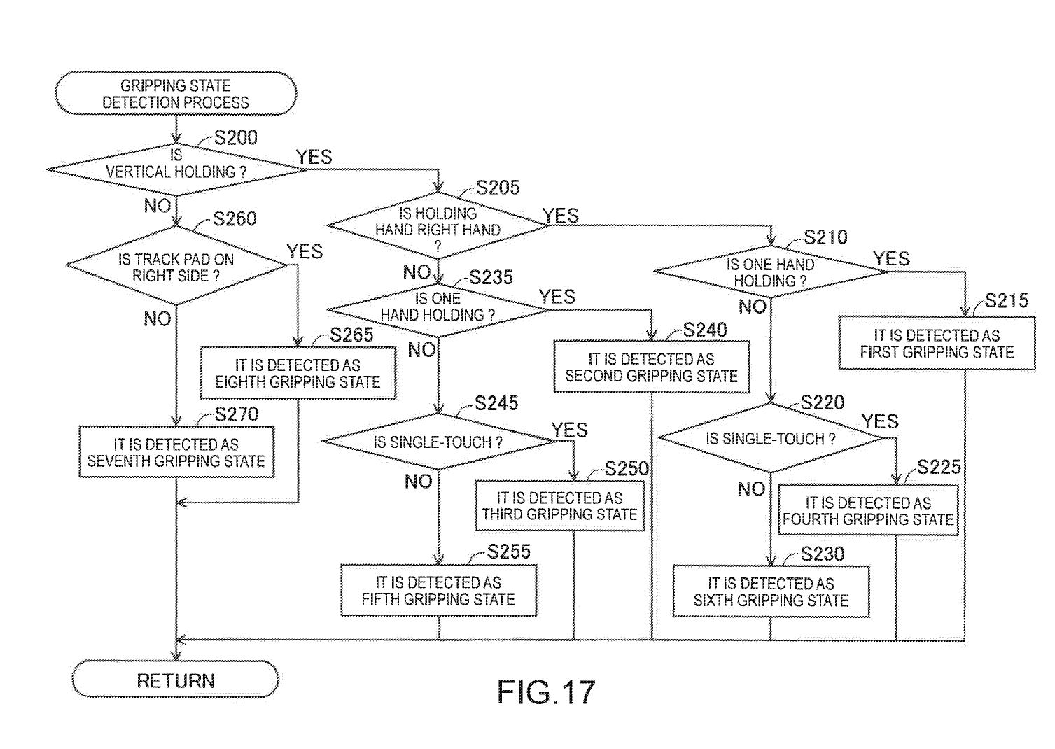

FIG. 17 is a flowchart illustrating the procedure of a gripping state detection process in detail. In the gripping state detection process, which one of the first gripping state to the eighth gripping state described above is detected by using the number, the positions (coordinates), the areas, and the like of the contact portions detected in the contact portion detection process (step S100). As illustrated in FIG. 17, the gripping state detector 155 determines whether or not it is vertical holding (step S200). In step S200, the direction of the input device 10 with respect to the image display unit 20 of the HMD 100 is detected based on the detection results of both the three-axis acceleration sensor of the six-axis sensor 111 included in the input device 10 and the six-axis sensor 235 included in the HMD 100.

In a case where it is determined as vertical holding (step S200: YES), the gripping state detector 155 determines whether the holding hand is the right hand (step S205). Specifically, the holding hand is determined by using the number, and the position (coordinates) and area of each of the detected contact portions. For example, the number, the positions (coordinates) and the areas of the contact portions in the track pad 14 in each gripping state are stored in advance in the setting data 123, and the gripping state detector 155 determines the holding hand, by comparing the number, the position (coordinates) and the area of each detected contact portion with the number, the position (coordinates) and the area of each contact portion stored in the setting data 123. More specifically, in a case where the number of contact portions on the left side of the track pad 14 is plural and the number of contact portions on the right side of the track pad 14 is one, it is determined that the holding hand is the right hand. On the other hand, in a case where the number of contact portions on the right side of the track pad 14 is plural and the number of contact portions on the left side of the track pad 14 is one, it is determined that the holding hand is the left hand.

In a case where it is determined that the holding hand is the right hand (step S205: YES), the gripping state detector 155 determines whether it is one hand holding (step S210). In step S210, similarly to the above-described step S205, it is determined whether it is one hand holding or both hands holding, by comparing the number, the positions (coordinates) and the areas of the detected contact portions with the number, the positions (coordinates) and the areas of the contact portions on the track pad 14 in each gripping state stored in the setting data 123. For example, in the case where the number of detected contact portions on the right side of the track pad 14 is two: a contact portion with the finger tip of the right thumb rf1 and a contact portion with the right thumb base rfb1, it is determined as one hand holding. On the other hand, in the case where the number of detected contact portions on the right side of the track pad 14 is one: a contact portion with the right thumb base rfb1, it is determined as both hands holding.

Further, for example, in the case that the position of the contact portion by the right thumb base rfb1 is detected as the position on the lower right side of the track pad 14, it is determined as one hand holding. On the other hand, in the case that the position of the contact portion by the right thumb base rfb1 is detected as the position along the right side surface of the track pad 14, it is determined as both hands holding. Further, for example, in the case where the area of the contact portion by the right thumb base rfb1 is smaller than a predetermined threshold value, it is determined as one hand holding. On the other hand, in the case where the area of the contact portion by the right thumb base rfb1 is the predetermined threshold value or more, it is determined as both hands holding. “Predetermined threshold value” means, as an example, the area of the contact portion by the right thumb base in the case of both hands holding. Since the area of the contact portion with the right thumb base is different due to the difference in hand size, the average value of the area of the contact portion with the right thumb base is calculated using experimental data or the like and the average value may be a threshold value.

In a case where it is determined as one hand holding (step S210: YES), the gripping state detector 155 detects as the first gripping state (step S215). After the execution of step S215, the gripping state detection process is completed, and step S110 illustrated in FIG. 16 is executed.

As illustrated in FIG. 17, when it is not determined as one hand holding in the above-described step S210 (step S210: NO), the gripping state detector 155 determines whether it is a single-touch or not (step S220). As described above, in a case where the total number of the contact portions excluding the support contact portion is one, it is determined as a single-touch; and in a case where the total number of contact portions excluding the support contact portion is two, it is determined as a multi-touch. In step S220, in the case where it is determined that it is single-touch (step S220: YES), the gripping state detector 155 detects as the fourth gripping state (step S225). On the other hand, in the case where it is determined that it is not a single-touch (step S220: NO), the gripping state detector 155 detects as the sixth gripping state (step S230). After the execution of step S225 and step S230, the gripping state detection process is completed, and step S110 illustrated in FIG. 16 is executed.

As illustrated in FIG. 17, in the case where it is determined that the holding hand is not the right hand in the above-described step S205 (step S205: NO), the gripping state detector 155 determines whether or not it is one hand holding as in the above-described step S210 (step S235). In a case where it is determined as one hand holding (step S235: YES), the gripping state detector 155 detects as the second gripping state (step S240). After the execution of step S240, the gripping state detection process is completed as in the case after the execution of the above-described step S215, and step S110 illustrated in FIG. 16 is executed.

In a case where it is not determined as one hand holding in the above-described step S235 (step S235: NO), it is determined whether it is a single-touch or not (step S245) as in the above-described step S220. In a case where it is determined as single-touch (step S245: YES), the gripping state detector 155 detects as the third gripping state (step S250). On the other hand, in the case where it is determined that it is not a single-touch (step S245: NO), the gripping state detector 155 detects as the fifth gripping state (step S255). After the execution of the process of each of step S250 and step S255, the gripping state detection process is completed, and step S110 illustrated in FIG. 16 is executed.

As illustrated in FIG. 17, in the case where it is not determined as vertical holding in the above-described step S200 (step S200: NO), the gripping state detector 155 determines whether or not the track pad 14 is on the right side (step S260). In step S260, it is detected whether the position of the track pad 14 of the input device 10 is on the right side or on the left side by using a three-axis acceleration sensor provided in the six-axis sensor 111. In the case where it is determined that the track pad 14 is on the right side (step S260: YES), the gripping state detector 155 detects as the eighth gripping state (step S265). On the other hand, in the case where it is determined that the track pad 14 is not on the right side (step S260: NO), the gripping state detector 155 detects as the seventh gripping state (step S270). After the execution of the process of each of step S265 and step S270, the gripping state detection process is completed. As illustrated in FIG. 16, after completion of the gripping state detection process (step S105), the input and output control unit 151 executes an input process (step S110).

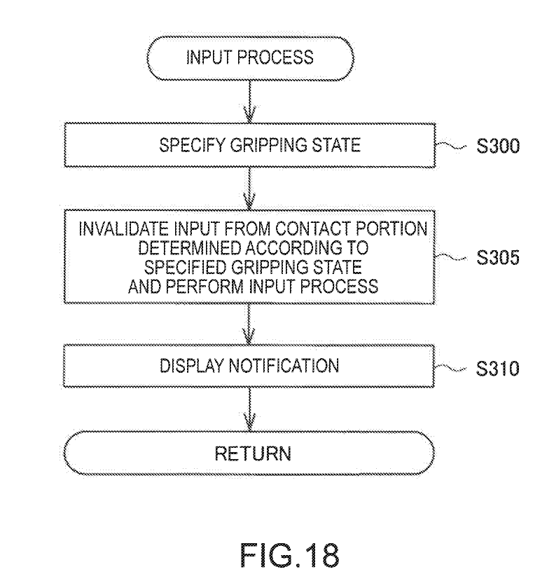

FIG. 18 is a flowchart illustrating the procedure of an input process in detail. As illustrated in FIG. 18, the input and output control unit 151 specifies a gripping state (step S300). Specifically, the input and output control unit 151 specifies a gripping state detected in the above-described gripping state detection process (step S105). After the execution of step S300, the input and output control unit 151 invalidates the input from the contact portion determined according to the specified gripping state and performs input processing (step S305).

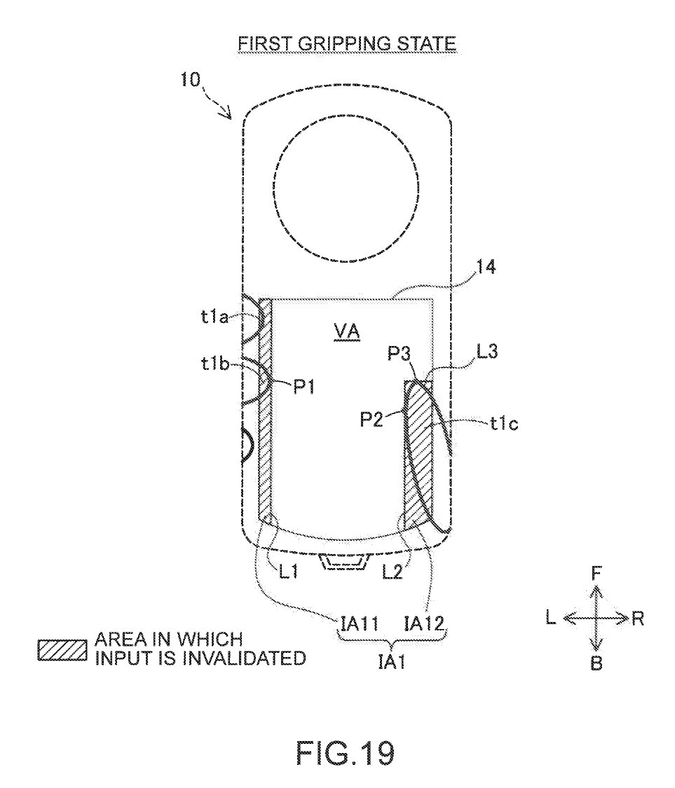

FIG. 19 is an explanatory diagram schematically illustrating an area in which an input determined according to the first gripping state is invalidated. FIG. 19 illustrates a state in which a contact portion t1a, a contact portion t1b, and a contact portion t1c are detected as the support contact portions. As illustrated in FIG. 19, an area for invalidating an input (hereinafter referred to as “input invalid area”) IA1 is composed of a first input invalid area IA11 and a second input invalid area IA12. The first input invalid area IA11 is an area surrounded by a straight line L1, the outer edge on the upper side of the track pad 14, the outer edge on the left side of the track pad 14, and the outer edge on the lower side of the track pad 14. The second input invalid area IA12 is an area surrounded by a straight line L2, a straight line L3, the outer edge on the right side of the track pad 14, and the outer edge on the lower side of the track pad 14.

The straight line L1 is a straight line that passes through a point P1 and is parallel to the longitudinal direction of the input device 10. The point P1 is the point on the rightmost (inward) side of a contact portion t1a and the contact portion t1b. In other words, the point P1 is the point on the rightmost (inward) side of each contact portion on the left side of the track pad 14. The straight line L2 is a straight line that passes through a point P2 and is parallel to the longitudinal direction of the input device 10. The point P2 is the point on the leftmost (inward) side of the contact portion t1c. In other words, the point P2 is the point on the leftmost (inward) side of the contact portion on the right side of the track pad 14. The straight line L3 is a straight line that passes through a point P3 and is parallel to the lateral direction of the input device 10. The point P3 is the uppermost point of the contact portion t1c. In other words, the point P3 is the point on the uppermost side of the contact portion on the right side of the track pad 14.

In the first gripping state, the input from the contact portion in the input invalid area IA1 is invalidated. On the other hand, the input from contact portions in the area VA other than the input invalid area IA1 in the track pad 14 is valid.

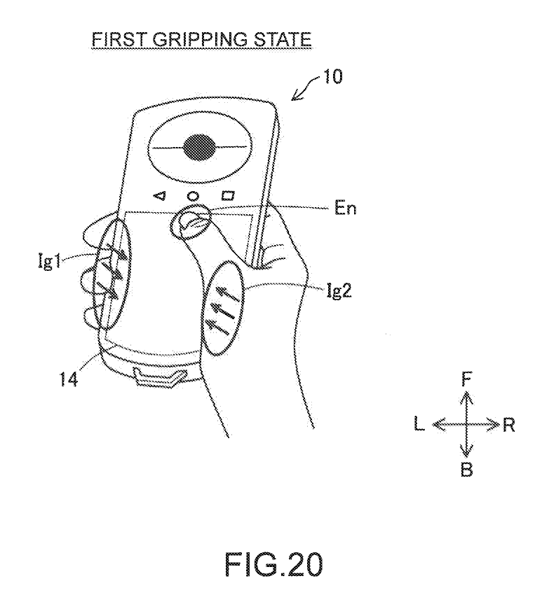

FIG. 20 is an explanatory diagram schematically illustrating a state of the input process in the first gripping state. In FIG. 20, reference symbols are not attached to the holding hand and fingers of the user for convenience of explanation. In addition, reference symbols are not attached to the operation unit other than the track pad 14 in the input device 10. This also applies to the following drawings. In the first gripping state illustrated in FIG. 20, the inputs from a contact portion Ig1 on the track pad 14 by the finger of the holding hand and a contact portion Ig2 on the track pad 14 by the base portion of the thumb of the holding hand are respectively invalidated, by the input/output unit not outputting a signal to the main processor 140. On the other hand, an input from a contact portion En on the track pad 14 operating the input device 10 is not invalidated, and the input is received and is processed.

As described above, the first gripping state is different from the second gripping state in that the hand supporting the input device 10 is the left hand lh instead of the right hand rh and the finger operating the input device 10 is the left thumb lf1 instead of the right thumb rf1. Therefore, although not shown, the input invalid area in the second gripping state is an area obtained by inverting the input invalid area IA1 in the first gripping state, more precisely, the first input invalid area IA11 and the second input invalid area IA12 with respect to a straight line passing through a substantially midpoint in the lateral direction of the track pad 14 and extending along the longitudinal direction.

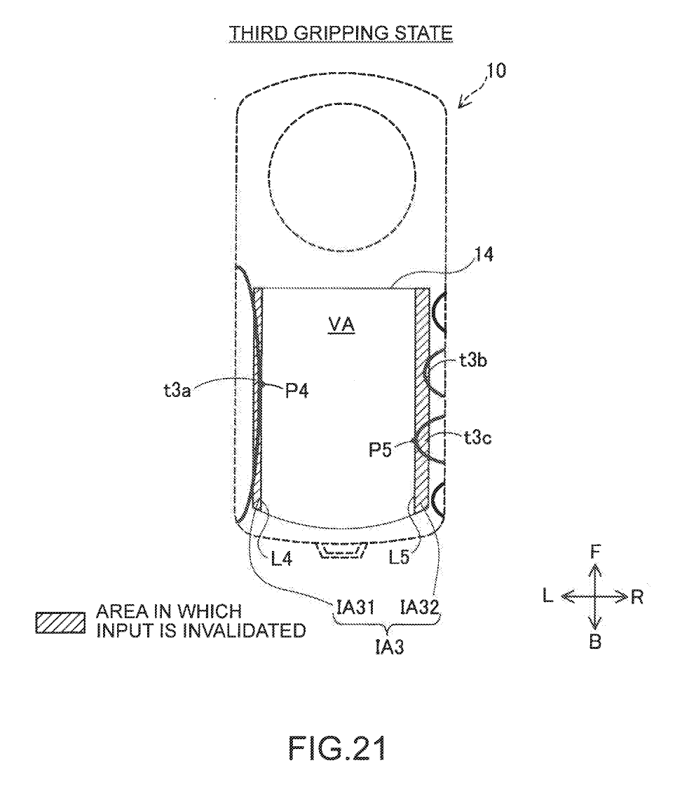

FIG. 21 is an explanatory diagram schematically illustrating an area in which an input determined according to the third gripping state is invalidated. FIG. 21 illustrates a state in which a contact portion t3a, a contact portion t3b, and a contact portion t3c are detected as the support contact portions. As illustrated in FIG. 21, an input invalid area IA3 includes a first input invalid area IA31 and a second input invalid area IA32. The first input invalid area IA31 is an area surrounded by a straight line L4, the outer edge on the upper side of the track pad 14, the outer edge on the left side of the track pad 14, and the outer edge on the lower side of the track pad 14. The second input invalid area IA32 is an area surrounded by a straight line L5, the outer edge on the upper side of the track pad 14, the outer edge on the right side of the track pad 14, and the outer edge on the lower side of the track pad 14.

The straight line L4 is a straight line that passes through a point P4 and is parallel to the longitudinal direction of the input device 10. The point P4 is the point on the rightmost (inward) side of the contact portion t3a. In other words, the point P4 is the point on the rightmost (inward) side of the contact portion on the left side of the track pad 14. The straight line L5 is a straight line that passes through a point P5 and is parallel to the longitudinal direction of the input device 10. The point P5 is the point on the leftmost (inward) side of the contact portion t3b and the contact portion t3c. In other words, the point P5 is the point on the leftmost (inward) side of each contact portion on the right side of the track pad 14.

In the third gripping state, the input from the contact portion in the input invalid area IA3 is invalidated. On the other hand, the input from contact portions in the area VA other than the input invalid area IA3 in the track pad 14 is valid.

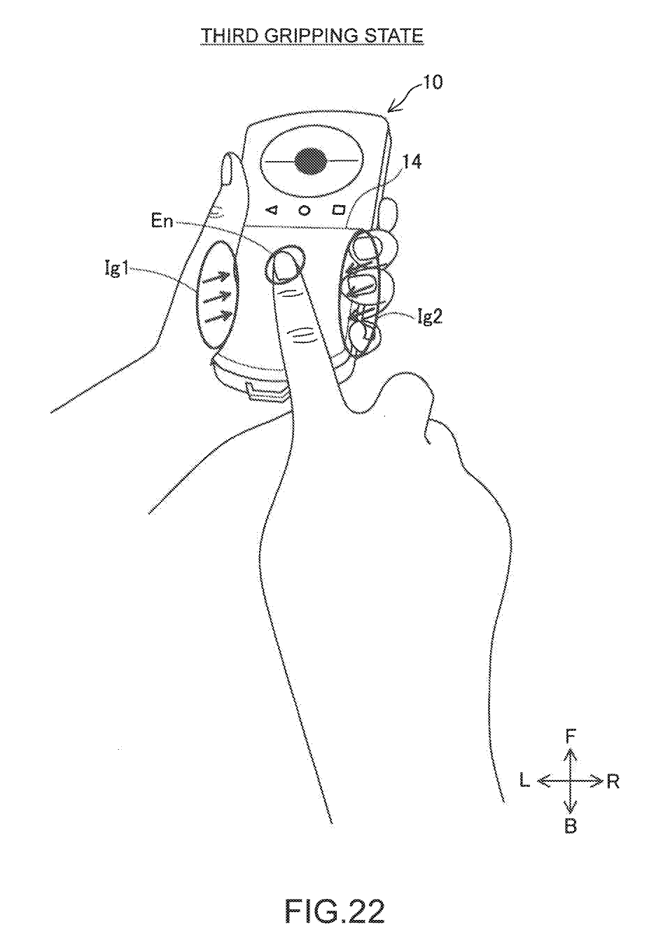

FIG. 22 is an explanatory diagram schematically illustrating a state of the input process in the third gripping state. In the third gripping state illustrated in FIG. 22, the inputs from the contact portion Ig1 on the track pad 14 by the base of the finger of the holding hand and the contact portion Ig2 on the track pad 14 by three fingers of the holding hand are respectively invalidated, by the input/output unit not outputting a signal to the main processor 140. On the other hand, an input from the contact portion En on the track pad 14 by the right index finger operating the input device 10 is not invalidated, and the input is received and is processed.

As described above, the third gripping state is different from the fourth gripping state in that the hand supporting the input device 10 is the right hand rh instead of the left hand lh and the finger operating the input device 10 is the left index finger lf2 instead of the right index finger rf2. Therefore, although not shown, the input invalid area in the fourth gripping state is an area obtained by inverting the input invalid area IA3 in the third gripping state, more precisely, the first input invalid area IA31 and the second input invalid area IA32 with respect to a straight line passing through a substantially midpoint in the lateral direction of the track pad 14 and extending along the longitudinal direction.

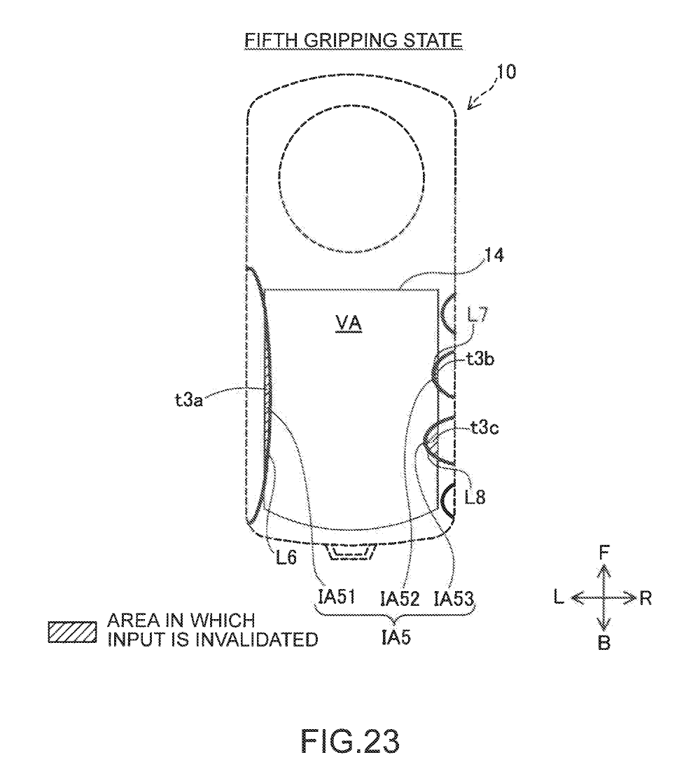

FIG. 23 is an explanatory diagram schematically illustrating an area in which an input determined according to the fifth gripping state is invalidated. FIG. 23 illustrates a state in which the contact portion t3a, the contact portion t3b, and the contact portion t3c similar to the support contact portions detected in the third gripping state illustrated in FIG. 21 are detected. As illustrated in FIG. 11, the fifth gripping state is a gripping state in which input by multi-touch is possible. Therefore, since a pinch in or pinch out operation can be performed, unlike the third gripping state, it is preferable that the contact portions where the input is invalidated are further reduced. Therefore, in the fifth gripping state, the input from the contact portion in the area along the outline of each of the contact portions t3a, t3b, and t3c is invalidated.

Specifically, as illustrated in FIG. 23, an input invalid area IA5 includes a first input invalid area IA51, a second input invalid area IA52, and a third input invalid area IA53. The first input invalid area IA51 is an area surrounded by a line L6 along the outer edge of the contact portion t3a and an outer edge on the left side of the track pad 14. In other words, the first input invalid area IA51 is all the areas in the contact portion t3a. The second input invalid area IA52 is an area surrounded by a line L7 along the outer edge of the contact portion t3b and an outer edge on the right side of the track pad 14. In other words, the second input invalid area IA52 is all the areas in the contact portion t3b. The third input invalid area IA53 is an area surrounded by a line L8 along the outer edge of the contact portion t3c and an outer edge on the right side of the track pad 14. In other words, the third input invalid area IA53 is all the areas in the contact portion t3c.

In the fifth gripping state, the input from the contact portions in the input invalid area IA5, that is, the first input invalid area IA5l, the second input invalid area IA52, and the third input invalid area IA53 is invalidated. On the other hand, the input from contact portions in the area VA other than the input invalid area IA5 in the track pad 14 is valid.

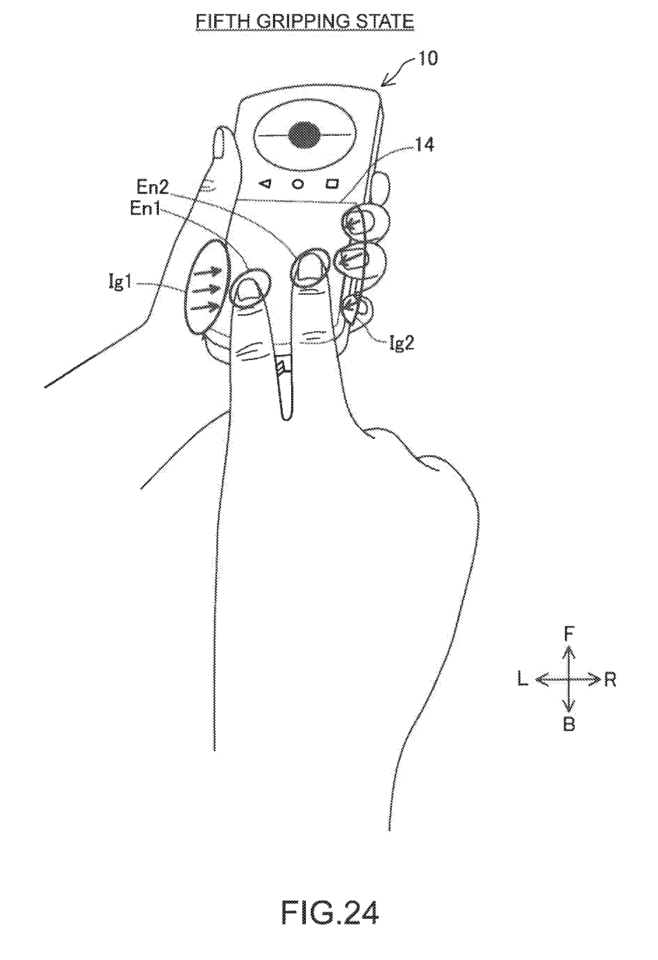

FIG. 24 is an explanatory diagram schematically illustrating a state of the input process in the fifth gripping state. In the fifth gripping state illustrated in FIG. 24, the inputs from the contact portion Ig1 on the track pad 14 by the base of the finger of the holding hand and the contact portion Ig2 on the track pad 14 by three fingers of the holding hand are respectively invalidated, by the input/output unit not outputting a signal to the main processor 140. On the other hand, inputs from a contact portion Ent on the track pad 14 by the right index finger operating the input device 10 and a contact portion En2 on the track pad 14 by the right middle finger are not invalidated, and the input is received and is processed.

As described above, the fifth gripping state is different from the sixth gripping state in that the hand supporting the input device 10 is the right hand rh instead of the left hand lh and the finger operating the input device 10 is the left index finger lf2 and the left middle finger lf3 instead of the right index finger rf2 and the right middle finger rf3. Therefore, although not shown, the input invalid area in the sixth gripping state is an area obtained by inverting the input invalid area IA5 in the fifth gripping state, more precisely, the first input invalid area IA51, the second input invalid area IA52 and the third input invalid area IA53 with respect to a straight line passing through a substantially midpoint in the lateral direction of the track pad 14 and extending along the longitudinal direction.

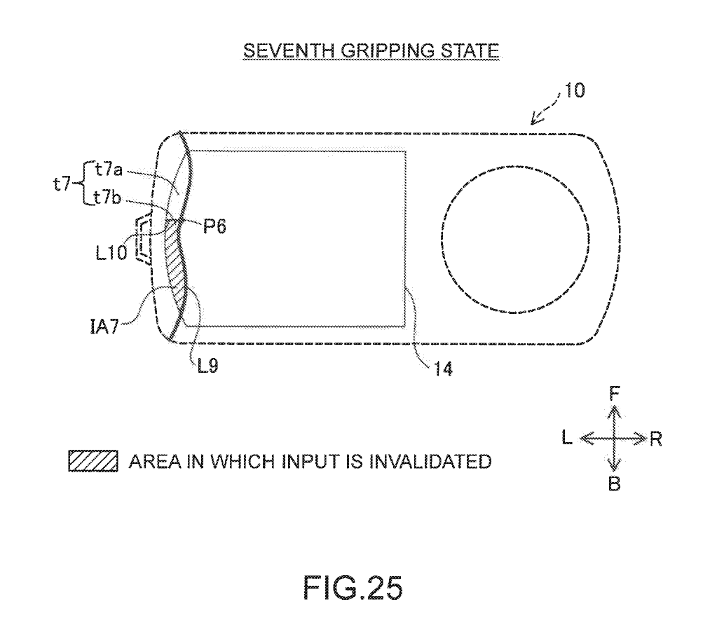

FIG. 25 is an explanatory diagram schematically illustrating an area in which an input determined according to the seventh gripping state is invalidated. FIG. 25 illustrates a state where a contact portion t7 is detected. The contact portion t7 includes a first contact portion t7a and a second contact portion t7b. The first contact portion t7a is a contact portion by the finger tip of the left thumb lf1 operating the track pad 14. The second contact portion t7b is a contact portion by the left thumb base lfb1 supporting the input device 10. In the seventh gripping state, the input from the second contact portion t7b of the two contact portions t7a and t7b is invalidated and the input from the first contact portion t7a is made valid.

Specifically, as illustrated in FIG. 25, the input invalid area IA7 is an area surrounded by a line L9 along the outer edge of the second contact portion t7b, a straight line L10, and an outer edge on the left side of the track pad 14. The straight line L10 is a straight line that passes through the point P6 and is parallel to the longitudinal direction of the input device 10. The point P6 is the point on the uppermost and rightmost (inward) side of the second contact portion t7b. Therefore, in the seventh gripping state, all the areas in the second contact portion t7b, which is the contact portion below the straight line L10, are invalidated. On the other hand, the first contact portion t7a, which is a contact portion on the upper side of the straight line L10, is not invalidated.

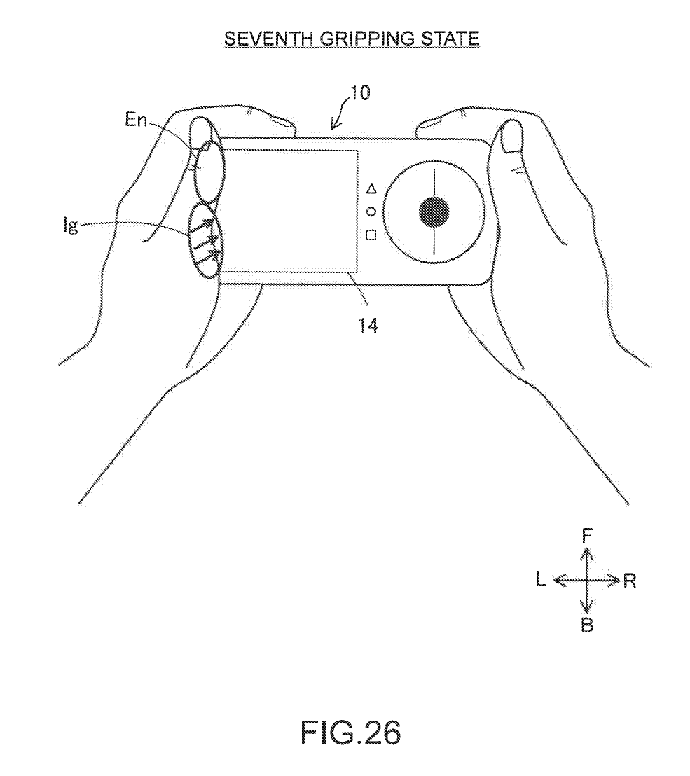

FIG. 26 is an explanatory diagram schematically illustrating an example of the input process in the seventh gripping state. As illustrated in FIG. 26, the input from the contact portion Ig on the track pad 14 by the base of the left thumb of the holding hand is invalidated, by the input/output unit not outputting a signal to the main processor 140. On the other hand, an input from the contact portion En on the track pad 14 by the fingertip of the left thumb operating the track pad 14 is not invalidated, and the input is received and is processed.

As described above, the seventh gripping state is different from the eighth gripping state in that the position of the track pad 14 is on the right side instead of the left side and the finger operating the track pad 14 is the right thumb rf1 instead of the left thumb lf1. Therefore, although not shown, the input invalid area in the eighth gripping state is an area obtained by inverting the input invalid area IA7 in the seventh gripping state with respect to a straight line passing through a substantially midpoint in the longitudinal direction of the input device 10 and extending along the lateral direction.

As illustrated in FIG. 18, after execution of step S305 described above, the display control unit 147 displays a notification (step S310).

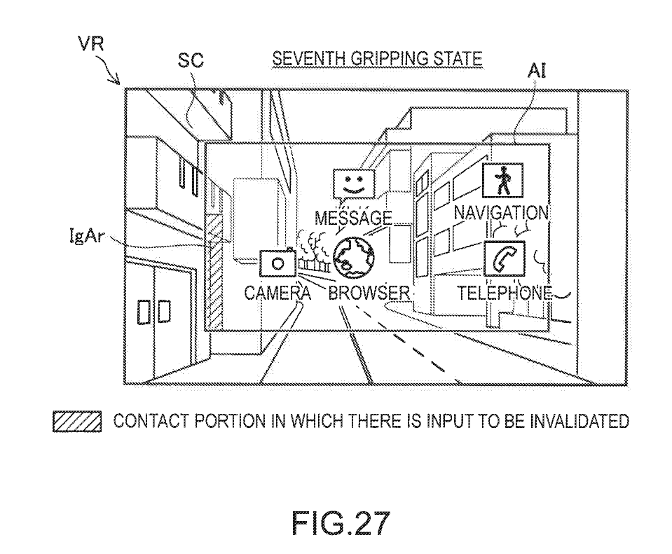

FIG. 27 is an explanatory diagram schematically illustrating an example of a notification display in the seventh gripping state. In FIG. 27, a field VR of view of the user is exemplified. The user views a display image AI superimposed on an outside world SC, for a portion where the display image AI is displayed, among the fields VR of view of the HMD 100. In the example illustrated in FIG. 27, the display image AI is a menu screen of the OS of the HMD 100. A lower left area IgAr of the display image AI is an area corresponding to the input invalid area IA7 in the seventh gripping state illustrated in FIG. 25. Such an area IgAr is highlighted, and emphasized on the display image A1. This informs the user that there is an input to be invalidated on the track pad 14.

Although not shown, in the present embodiment, similarly also in the above-described other gripping states, in a case where there is an input from the contact portion determined according to each gripping state, the display control unit 147 displays a notification by highlighting an area corresponding to the contact portion. For example, the notification display is not limited to the highlight display, but any other display modes may be used as long as it is a display mode in which it is possible to notify the user that there is an input to be invalidated, such as a configuration of changing the brightness of the area IgAr periodically and displaying it or a configuration of blurring the color the area IgAr and displaying it. Further, the notification may be continuously displayed while the input device 10 is held by the user, or may be displayed each time the input is made in each input invalid area.

As illustrated in FIG. 18, when the notification is displayed (step S310), the input process is completed. After completion of the input process, the process returns to the above-described step S100 as illustrated in FIG. 16.

According to the input device 10 in the present embodiment described above, it includes the contact detector 153 that detects the contact portion on the operation surface of the track pad 14 and the gripping state detector 155 that detects the gripping state of the input device 10, and invalidates an input from the contact portion determined according to the detected gripping state, among the detected contact portions, so erroneous input can be reduced. In addition, compared with a configuration in which input from a contact portion of a predetermined area is invalidated irrespective of the gripping state, a reduction of the input possible area can be suppressed.

Since the gripping state includes the direction and the holding method of the input device 10, it is possible to invalidate the input from the contact portion determined according to the direction and the holding method of the input device 10. In addition, since the gripping state detector 155 detects the gripping state by using the number of the contact portions, areas of the contact portions, and positions of the contact portions, the gripping state can be accurately detected.

In addition, since the gripping state detector 155 specifies the support contact portion among the contact portions and distinguishes between single-touch and multi-touch based on the number of contact portions excluding the specified support contact portions, it can be distinguished between the single-touch and the multi-touch with high accuracy.

In addition, in a case where there is an input to be invalidated in the contact portion, the image display unit 20 of the HMD 100 connected to the input device 10 is caused to display a notification, so that in a case where the user wears the HMD 100 on the head and performs an operation without looking at the track pad 14, the user can easily know that there is an input to be invalidated, thereby improving user convenience.

### B. Modification Example

### B1. Modification Example 1

In the above embodiment, in the gripping state detection process (step S105), a state in which the input device 10 is supported by hand is detected as the gripping state, but the invention is not limited thereto. For example, a state in which the input device 10 is placed on a desk may be detected as a gripping state. In this case, since the contact portion is not detected, the input invalid area need not be defined. In addition, in such a gripping state, the direction and the holding method of the input device 10 may not be detected. Even with such a configuration, the same effects as those of the above-described embodiment can be obtained. In addition, the time required for the gripping state detection process can be reduced, or the processing load can be reduced.

### B2. Modification Example 2

In the above embodiment, although the contact portion with the fingertip or the base portion of a finger is detected as the contact portion, a contact portion with a stylus pen may be detected. Even with such a configuration, the same effects as those of the above-described embodiment can be obtained.

### B3. Modification Example 3

In the above embodiment, in the gripping state detection process (step S105), a gripping state is detected by using the number of contact portions and the like, but the invention is not limited thereto. For example, the gripping state may be detected by imaging the gripping state so as to include the input device 10 and the holding hand by the camera 61, and analyzing the image obtained by the imaging. In this case, a gripping state may be detected by storing each gripping state and the position of the contact portion in each gripping state in the setting data 123 in advance in association with each other, and comparing the position of each contact portion detected from the captured image with the position of the contact portion in each gripping state stored in the setting data 123. In addition, for example, in a configuration in which the HMD 100 and the input device 10 each have a nine-axis sensor, a holding hand may be detected by detecting the relative position of the input device 10 with respect to the HMD 100 by using the nine-axis sensor. Even with such a configuration, the same effects as those of the above-described embodiment can be obtained.

### B4. Modification Example 4

In the above embodiment, in the contact portion detection process (step S100), contact portions are detected by using an electrostatic sensor, but the invention is not limited thereto. For example, the contact portion may be detected by imaging the gripping state of the input device 10 by the camera 61, and analyzing the image obtained by the imaging. Even with such a configuration, the same effects as those of the above-described embodiment can be obtained.

### B5. Modification Example 5

In the above embodiment, a notification is displayed, but the invention is not limited thereto. For example, a notification may not be displayed. The same effect as that of the above embodiment can be obtained as long as it is configured to invalidate the input from the contact portion determined according to the detected gripping state regardless of the presence or absence of the notification display.

### B6. Modification Example 6

In the above embodiment, the display device on which the notification is displayed is a transmissive head mounted display (HMD 100), but the invention is not limited thereto. For example, it may be a head-up display (HUD), a video see-through type HMD, or a non-transmissive head mounted display. Further, a stationary display device may be used. In addition, the display device and the input device 10 may be connected in a wired manner as in the above-described embodiment, or they may be wirelessly connected by wireless communication complying with the wireless LAN standards, for example. Even with such a configuration, the same effect as that of each of the above-described embodiments can be obtained.

### B7. Modification Example 7

In the above embodiment, in the gripping state detection process (step S105), a gripping state is detected by using the number of contact portions, the positions of the contact portions, and the areas of the contact portions, but the invention is not limited thereto. For example, the gripping state may be detected by omitting the area of the contact portion and utilizing the number of contact portions and the positions of the contact portions. For example, the gripping state may be detected by omitting the positions of the contact portions and utilizing the number of contact portions and the areas of the contact portions. That is, in general, as long as the gripping state is detected by using at least one of the number of contact portions, the areas of the contact portions, and the positions of the contact portions, the same effect as that of the above-described embodiments can be obtained.

### B8. Modification Example 8

In the above embodiment, the gripping state detection process (step S105) is executed every time in the input receiving process, but the invention is not limited thereto. For example, in a case where the position of the detected contact portion substantially coincides with the position of the contact portion detected at previous time, it is determined that the gripping state has not changed and the gripping state detection process may not be executed. Further, for example, when the gripping state detection process is executed, the position of the detected contact portion and the specified gripping state are associated with each other and stored in the setting data 123 as a table, and thereafter, in a case where the gripping state detection process is performed with the changed position of the contact portion, a gripping state associated with the position of the contact portion after the change may be detected by referring to the table. In addition, for example, the definition of each gripping state is stored in advance in the setting data 123, and when the gripping state detection process is executed, a gripping state may be detected by referring to the definition of the gripping state. Even with such a configuration, the same effects as those of the above-described embodiment can be obtained. In addition, the time required for the input receiving process can be reduced, or the processing load can be reduced.

### B9. Modification Example 9

In the above embodiment, a notification is displayed on the image display unit 20 of the HMD 100, but the invention is not limited thereto. For example, a notification may be displayed on the touch key 12 of the input device 10. In this case, each key on the touch key 12 is associated with a contact portion of which the input is invalidated, and a notification may be displayed by turning on the LED of the corresponding key. Even with such a configuration, the same effects as those of the above-described embodiment can be obtained.

### B10. Modification Example 10

In the above embodiment, in the gripping state detection process (step S105), determination (step S260) as to whether or not the track pad 14 in the case of horizontal holding is on the right side is performed using the electrostatic sensor, but the invention is not limited thereto. For example, it may be determined using an acceleration sensor. In the use state of the input device 10, the connection cable 40 is connected to the connector on the track pad 14 side, and thus gravity is applied to the track pad 14 side as compared with the cross key 16 side. Therefore, by using the acceleration sensor, the position of the track pad 14 can be easily determined, and the time required for the process of step S260 can be reduced, or the processing load can be reduced.

### B11. Modification Example 11

In the above embodiment, in the gripping state detection process (step S105), determination (step S200) as to whether or not it is vertical holding is performed using the input device 10 and the acceleration sensor of the HMD 100, but the invention is not limited thereto. For example, it may be determined using only the acceleration sensor of the input device 10. Further, for example, it may be determined using a gyro sensor. Even with such a configuration, the same effects as those of the above-described embodiment can be obtained.

### B12. Modification Example 12

In the above embodiment, the input/output unit does not output a signal to the main processor 140, thereby invalidating the input from the input invalid area, but the invention is not limited thereto. For example, although a signal is output from the input/output unit to the main processor 140, a signal in the input invalid area among the signals received by the HMD 100 may be invalidated. In this case, information such as the coordinates of the input invalid area in each gripping state is output in advance from the input device 10 to the HMD 100. The HMD 100 may invalidate such a signal by determining whether or not the signal output from the input device 10 is a signal due to an input in the input invalid area, based on information such as the previously acquired coordinates. Even with such a configuration, the same effects as those of the above-described embodiment can be obtained.

### B13. Modification Example 13

In the above embodiment, the multi-touch is a case where the total number of contact portions excluding the specified support contact portion is two, but the invention is not limited thereto. For example, the case where the total number of contact portions excluding the specified support contact portion is three or four may be determined as multi-touch. That is, in general, the same effect as in the above embodiment can be obtained as long as it is distinguished between the single-touch and the multi-touch based on the number of contact portions excluding the specified support contact portion.

### B14. Modification Example 14

In the above embodiment, the input device 10 is an input device (controller) that controls the HMD 100, but the invention is not limited thereto. For example, input devices such as a wristwatch and a smartphone may be used. Further, for example, in a case where the input device is a smartphone, the smartphone may be held by a so-called smartphone case instead of the hand of the user, or may be held by a holder such as a resin armor the like. Even with such a configuration, the same effects as those of the above-embodiment can be obtained.

### B15. Modification Example 15

In the above embodiment, the contact portion in the track pad 14 is detected in the contact portion detection process (step S100), but the invention is not limited thereto. For example, in addition to the contact portions on the track pad 14, the contact portions on the cross key 16 and the touch key 12 may be detected. In this case, the input invalid area may be set for the detected contact portion, with the cross key 16 and the touch key 12 as a part of the track pad 14. Even with such a configuration, the same effects as those of the above-embodiment can be obtained.

### B16. Modification Example 16

In the above embodiment, in the gripping state detection process (step S105), a gripping state may be detected by utilizing a change in the state of the contact portion. For example, a gripping state may be detected by detecting the area of the contact portion and the movement direction of the innermost position (coordinates) of the contact portion and determining whether or not the detected movement direction is heading inward. In a case where it is determined that the detected movement direction is heading inward, it may be detected as vertical holding as an example. For example, a gripping state may be detected by detecting the area of the contact portion and the moving speed of the innermost position (coordinates) of the contact portion and determining whether or not the detected moving speed is stopped after being accelerated. Further, for example, the gripping state may be detected not only by detecting the innermost position in the contact portion but also by detecting the movement direction and moving speed of the position of the center of gravity in the contact portion. Even with such a configuration, the same effects as those of the above-embodiment can be obtained.

### B17. Modification Example 17

In the above embodiment, the contact portion detected in the contact portion detection process (step S100) is parts of the track pad 14 in contact with the finger or the like in the track pad 14, but the invention is not limited thereto. For example, a fingertip or the base portion of a finger touching the track pad 14 may be detected as the contact portion. That is, the contact portion means a broad concept including a portion (area) where a finger or the like is in contact with the track pad 14 and a finger or the like that is in contact with the track pad 14. Even with such a configuration, the same effects as those of the above-embodiment can be obtained.

The invention is not limited to the above-described embodiments and modification examples, and can be realized in various configurations without departing from the spirit thereof. For example, the technical features of the embodiments and modification examples corresponding to the technical features of each aspect described in the summary of invention section can be replaced or combined as appropriate, in order to solve some or all of the above-mentioned problems, or in order to achieve some or all of the aforementioned effects. Unless its technical features are described as essential herein, they can be deleted as appropriate.

The entire disclosure of Japanese Patent Application No. 2017-047534, filed Mar. 13, 2017 is expressly incorporated by reference herein.

What is claimed is:

1. An input device comprising:
a plurality of operation units including an operation unit having an operation surface for receiving a touch operation;
a contact detector that detects contact portions on the operation surface;
a gripping state detector that detects a gripping state of the input device; and
a control unit that processes an input from the operation unit,
wherein the control unit invalidates an input from a contact portion determined according to the detected gripping state, among the detected contact portions.

2. The input device according to claim 1,
wherein the gripping state includes a direction of the input device.

3. The input device according to claim 1,
wherein the gripping state includes a holding method of the input device.

4. The input device according to claim 1,
wherein the gripping state detector detects the gripping state, by using at least one of the number of the contact portions, an area of each of the contact portions, and a position of each of the contact portions.

5. The input device according to claim 1,
wherein the gripping state includes a single-touch and a multi-touch on the operation surface, and
wherein the gripping state detector
specifies a support contact portion for supporting the input device among the contact portions, and
distinguishes between the single-touch and the multi-touch, based on the number of contact portions excluding the specified support contact portion, among the contact portions.

6. The input device according to claim 1, further comprising:
a display control unit that causes a display device connected to the input device to display a notification, in a case where there is an input to be invalidated in the contact portion.

7. The input device according to claim 6,
wherein the display device is a head mounted display.

8. An input control method of an input device including a plurality of operation units including an operation unit having an operation surface for receiving a touch operation, the method comprising:
detecting contact portions on the operation surface;
detecting a gripping state of the input device; and
processing an input from the operation unit,
wherein the processing an input includes invalidating an input from a contact portion determined according to the detected gripping state, among the detected contact portions.

9. A computer program for controlling an input in an input device including a plurality of operation units including an operation unit having an operation surface for receiving a touch operation, the computer program causing a computer to implement
a contact detection function of detecting contact portions on the operation surface;
a gripping state detection function of detecting a gripping state of the input device; and
an input processing function of processing an input from the operation unit,
wherein the input processing function includes a function of invalidating an input from a contact portion determined according to the detected gripping state, among the detected contact portions.
